(19) United States
(12) Patent Application Publication
(10) Pub. No.: US 2015/0377823 A1
(43) Pub. Date: Dec. 31, 2015

(54) LIMITING-CURRENT TYPE GAS SENSOR, FABRICATION METHOD OF THE LIMITING-CURRENT TYPE GAS SENSOR AND SENSOR NETWORK SYSTEM

(71) Applicant: ROHM CO., LTD., Kyoto (JP)

(72) Inventor: Shunsuke AKASAKA, Kyoto (JP)

(73) Assignee: ROHM CO., LTD., Kyoto (JP)

(21) Appl. No.: 14/846,869

(22) Filed: Sep. 7, 2015

Related U.S. Application Data
(63) Continuation of application No. PCT/JP2013/081761, filed on Nov. 26, 2013.

(30) Foreign Application Priority Data
Mar. 8, 2013 (JP) 2013-046436
Aug. 21, 2013 (JP) 2013-171021

(51) Int. Cl. G01N 27/406; G01N 27/416; G01N 27/407

(52) U.S. Cl. CPC G01N 27/4065; G01N 27/4074; G01N 27/4075; G01N 27/4166; G01N 27/4071; G01N 27/4067

(57) ABSTRACT

A limiting-current type gas sensor includes: an Si substrate (1); a micro heater (2) formed on the Si substrate (1); a solid electrolyte layer (4) having ion conductivity formed on the Si substrate (1); a pair of positive and negative porous electrodes (5a, 5b) adhesively formed on the solid electrolyte layer (4); and a detection circuit (8) configured to detect predetermined gas density in measured gas with a limiting current method by applying voltage between the pair of the positive and negative porous electrodes (5a, 5b). There are provided the limiting-current type gas sensor which can reduce power consumption, a fabrication method of such a limiting-current type gas sensor, and a sensor network system.

### CROSS REFERENCE TO RELATED APPLICATIONS

This is a continuation application (CA) of PCT Application No. PCT/JP2013/081761, filed on Nov. 26, 2013, which claims priority to Japan Patent Applications No. P2013-46436 filed on Mar. 8, 2013 and No. P2013-171021 filed on Aug. 21, 2013 and is based upon and claims the benefit of priority from prior Japanese Patent Applications P2013-46436 filed on Mar. 8, 2013 and No. P2013-171021 filed on Aug. 21, 2013 and PCT Application No. PCT/JP2013/081761, filed on Nov. 26, 2013, the entire contents of each of which are incorporated herein by reference.

### FIELD

The embodiments described herein relate to a limiting-current type gas sensor for detecting a predetermined gas density in atmosphere under measurement with a limiting current method, a fabrication method of such a limiting-current type gas sensor, and a sensor network system.

### BACKGROUND

Conventionally, resistance change type, capacitance change type, zirconia (ZrO₂) solid oxide type humidity sensors, etc. have been known as humidity sensors for detecting a vapor density in measured gas. While there are advantages in which the polymer membrane resistance change type humidity sensors are inexpensive and are easy to from a device, there are disadvantages in which measurement accuracies in low-humidity regions are low, and temperature dependency is large, and elution due to condensation leads to element deteriorations and breakdowns. On the other hand, while there are advantages in which the capacitance change type humidity sensors have sufficient linearity, are measurable in whole region of relative humidity, and have small temperature dependency, there is disadvantages in which the capacitance change type humidity sensors have significant effects of waters (tap water etc.) other than a pure water and organic solvents, etc. While capacitance in humidity of 0% RH is hundreds of pF, a capacitance change when 1% RH is changed is equal to or less than 1 pF, and therefore periodic calibration is required for exact humidity measurement. While the capacitance change type humidity sensor is an effective device when highly accurate humidity measurement is not required in ordinary office environments, it is unexpected usage in highly accurate humidity measurement, a possible atmosphere of condensation or exposure to gas (for weather observations, or for bathroom), and atmospheres of high temperatures equal to or greater than 100 degrees C. Polymeric materials need to be newly developed to improve durability thereof. While future research and development are expected, novel material developments require many time periods and costs.

There have been available humidity sensors using zirconia solid electrolytes used for humidity measurements in high temperatures. Oxygen sensors using zirconia solid electrolytes have been used for the purpose of improving combustion efficiencies of automobiles, and reduction of NOx, and there is sufficient results for durability as materials. However, since the temperature of zirconia is increased to hundreds of degrees C. when using it, power consumption is as high as 100 W, and handling of high-temperature substance is still more difficult, its mart is limited to a part of industrial uses.

Consequently, in recent years, attention is being given to limiting-current type sensors using zirconia thin film. Such a kind of the limiting-current type oxygen sensor has an advantages of high reliability and sufficient linearity.

The principle of the limiting-current type gas sensor is as follows: Firstly, if voltage is applied to a zirconia solid electrolyte, an oxygen ion ionized with a catalyst electrode will conduct from one side of solid electrolyte to another side thereof. If an amount of oxygen gas inhaled to the electrolyte using small holes, porousness, etc. is limited at that time, saturation phenomena in which a current becomes constant value will appear even if the voltage is increased. Such a current is called a limiting current and is proportional to a surrounding oxygen density. Accordingly, if a constant voltage is applied thereto, the oxygen density can be detected on the basis of a flowing current value. It is also possible to detect a vapor density in accordance with the similar principle if the voltage to be applied is switched.

### SUMMARY

However, in accordance with the limiting-current type gas sensor, it is necessary to heat a zirconia solid electrolyte at approximately 700 degrees C. to conduct an oxygen ion. The power consumption even of thin-film type sensors in that case was equal to or greater than 1 W, and therefore high power consumption was required.

The embodiments provide a limiting-current type gas sensor which can reduce power consumption, a fabrication method of such a limiting-current type gas sensor, and a sensor network system.

According to one aspect of the embodiment, there is provided a limiting-current type gas sensor comprising: an Si substrate; a micro heater formed on the Si substrate or under the Si substrate; a solid electrolyte layer having ion conductivity formed on the Si substrate; a pair of positive and negative porous electrodes adhesively formed on the solid electrolyte layer; and a detection circuit configured to detect predetermined gas density in measured gas with a limiting current method by applying voltage between the pair of the positive and negative porous electrodes.

According to another aspect of the embodiment, there is provided a fabrication method of a limiting-current type gas sensor, the method comprising: forming a Si substrate; forming a micro heater on the Si substrate or under the Si substrate; forming a solid electrolyte layer having ion conductivity on the Si substrate; and adhesively forming a pair of positive and negative porous electrodes on the solid electrolyte layer.

According to still another aspect of the embodiment, there is provided a sensor network system comprising a limiting-current type gas sensor, the limiting-current type gas sensor comprising: an Si substrate; a micro heater formed on the Si substrate or under the Si substrate; a solid electrolyte layer having ion conductivity formed on the Si substrate; a pair of positive and negative porous electrodes adhesively formed on the solid electrolyte layer; and a detection circuit configured to detect predetermined gas density in measured gas with a limiting current method by applying voltage between the pair of the positive and negative porous electrodes.

According to the embodiments, there can be provided the limiting-current type gas sensor which can reduce power consumption, the fabrication method of such a limiting-current type gas sensor, and the sensor network system.

### BRIEF DESCRIPTION OF DRAWINGS

FIG. 1 is a schematic cross-sectional structure diagram of a limiting-current type gas sensor according to a first embodiment.

FIG. 2 is a schematic cross-sectional structure diagram of another limiting-current type gas sensor according to the first embodiment.

FIG. 3 is a schematic cross-sectional structure diagram of a limiting-current type gas sensor according to a comparative example 1.

FIG. 4 is a schematic bird's-eye view configuration diagram of another limiting-current type gas sensor according to the comparative example 1.

FIG. 5A shows a graph showing sensor characteristics of the limiting-current type gas sensor according to the comparative example 1, which is a graph showing current-voltage characteristics.

FIG. 5B shows a graph showing sensor characteristics of the limiting-current type gas sensor according to the comparative example 1, which is a graph showing current-oxygen density characteristics.

FIG. 6 is a schematic cross-sectional structure diagram of a limiting-current type gas sensor according to a comparative example 2.

FIG. 7 is a schematic cross-sectional structure diagram of another limiting-current type gas sensor according to the comparative example 2.

FIG. 8A is a process chart of forming an anode electrode and a cathode electrode, in a fabrication method of a limiting-current type gas sensor according to a comparative example 3.

FIG. 8B is a process chart of forming an ionic conductor film, in the fabrication method of the limiting-current type gas sensor according to the comparative example 3.

FIG. 8C is a process chart of forming a Zr—Y film, in the fabrication method of the limiting-current type gas sensor according to the comparative example 3.

FIG. 8D is a process chart of forming a gas diffusion layer, in the fabrication method of the limiting-current type gas sensor according to the comparative example 3.

FIG. 9 is a schematic block configuration diagram in the case of detecting a gas density using the limiting-current type gas sensor according to the first embodiment.

FIG. 10 is a flow chart showing an operation of detecting a gas density using the limiting-current type gas sensor shown in FIG. 9.

FIG. 11A is a schematic planar pattern configuration diagram showing the limiting-current type gas sensor according to the first embodiment.

FIG. 11B is a schematic cross-sectional structure diagram taken in the line I-I of FIG. 11A.

FIG. 12A is a process chart of forming a micro heater in a fabrication method of the limiting-current type gas sensor according to the first embodiment.

FIG. 12B is a process chart of forming an insulating film in a fabrication method of the limiting-current type gas sensor according to the first embodiment.

FIG. 12C is a process chart of forming a solid electrolyte layer in the fabrication method of the limiting-current type gas sensor according to the first embodiment.

FIG. 12D is a process chart of forming a pair of positive and negative porous electrodes in the fabrication method of the limiting-current type gas sensor according to the first embodiment.

FIG. 12E is a process chart of forming a porous membrane in the fabrication method of the limiting-current type gas sensor according to the first embodiment.

FIG. 12F is a process chart of performing anisotropic etching in the fabrication method of the limiting-current type gas sensor according to the first embodiment.

FIG. 12G is a process chart of forming a thin-type sensor chip in the fabrication method of the limiting-current type gas sensor according to the first embodiment.

FIG. 13 is a schematic cross-sectional structure diagram showing a modified example of the limiting-current type gas sensor according to the first embodiment.

FIG. 14 is a schematic cross-sectional structure diagram showing another modified example of the limiting-current type gas sensor according to the first embodiment.

FIG. 15A is a schematic planar pattern configuration diagram showing a limiting-current type gas sensor according to a second embodiment.

FIG. 15B is a schematic cross-sectional structure diagram taken in the II-II of FIG. 15A, in the limiting-current type gas sensor according to the second embodiment.

FIG. 16A is a process chart of forming a micro heater in a fabrication method of the limiting-current type gas sensor according to the second embodiment.

FIG. 16B is a process chart of forming an insulating film in the fabrication method of the limiting-current type gas sensor according to the second embodiment.

FIG. 16C is a process chart of forming a solid electrolyte layer in the fabrication method of the limiting-current type gas sensor according to the second embodiment.

FIG. 16D is a process chart of forming a pair of positive and negative porous electrodes in the fabrication method of the limiting-current type gas sensor according to the second embodiment.

FIG. 16E is a process chart of forming a porous membrane in the fabrication method of the limiting-current type gas sensor according to the second embodiment.

FIG. 16F is a process chart of forming a cavity in the fabrication method of the limiting-current type gas sensor according to the second embodiment.

FIG. 17 is a schematic cross-sectional structure diagram showing a modified example of the limiting-current type gas sensor according to the second embodiment.

FIG. 18 is a schematic cross-sectional structure diagram showing another modified example of the limiting-current type gas sensor according to the second embodiment.

FIG. 19 is a schematic bird's-eye view configuration diagram of a limiting-current type gas sensor according to a third embodiment.

FIG. 20 is a schematic planar pattern configuration diagram showing the limiting-current type gas sensor shown in FIG. 19.

FIG. 21 is a schematic cross-sectional structure diagram taken in the line of FIG. 20.

FIG. 22 is a schematic bird's-eye view configuration diagram showing a state where a beam structure body of the limiting-current type gas sensor according to the third embodiment is heated.

FIG. 23 is a schematic bird's-eye view configuration diagram enlarging a portion of the beam structure body shown in FIG. 22.

FIG. 24 is a diagram for explaining the size of the beam structure body B shown in FIG. 22.

FIG. 25 is a schematic bird's-eye view configuration diagram showing a state where the beam structure body of the limiting-current type gas sensor according to the third embodiment is heated at 25 mW.

FIG. 26 is a graph showing a relationship between a temperature T of the beam structure body and time t of integral power Es in the case of heating the beam structure body shown in FIG. 25 at 25 mW.

FIG. 27A is a diagram for explaining a comparative example, which is a graph showing a relationship between input power Pᵢ to the limiting-current type gas sensor and time t.

FIG. 27B is a diagram for explaining the comparative example, which is a graph showing a relationship between a temperature T of the beam structure body and time t of integral power Es in the case of input the power Pᵢ shown in FIG. 27A.

FIG. 28A is a diagram for explaining the third embodiment, which is a graph showing a relationship between input power Pᵢ to the limiting-current type gas sensor and time t

FIG. 28B is a diagram for explaining the third embodiment, which is a graph showing a relationship between a temperature T of the beam structure body and time t of integral power Es in the case of input the power Pᵢ shown in FIG. 28A.

FIG. 29A is a diagram for explaining the third embodiment, which is a graph showing a relationship between input power Pᵢ to the limiting-current type gas sensor and time t.

FIG. 29B is a diagram for explaining the third embodiment, which is a graph showing a relationship between a temperature T of the beam structure body and time t of integral power Es in the case of input the power Pᵢ shown in FIG. 29A.

FIG. 30A is a diagram for explaining a third embodiment, which is a schematic bird's-eye view configuration diagram showing a state where the limiting-current type gas sensor is mounted on a printed circuit board.

FIG. 30B is a diagram for explaining a third embodiment, which is a graph showing input power to the limiting-current type gas sensor shown in FIG. 30A.

FIG. 30C is a diagram for explaining the third embodiment, which is a graph showing a temperature of the beam structure body in the case of input the power shown in FIG. 30B.

FIG. 31A is a diagram for explaining a third embodiment, which is a schematic bird's-eye view configuration diagram showing a state where the limiting-current type gas sensor is mounted on a printed circuit board.

FIG. 31B is a diagram for explaining the third embodiment, which is a graph showing a relationship between input power Pᵢ to the limiting-current type gas sensor shown in FIG. 31A and time t.

FIG. 31C is a diagram for explaining the third embodiment, which is a graph showing a relationship between a temperature T of a center portion of a silicon (Si) substrate and time t of integral power Es in the case of input the power Pᵢ shown in FIG. 31B.

FIG. 31D is a graph showing a relationship between a temperature T of a portion directly under the Si substrate of the printed circuit board and time t, in the case of input the power Pᵢ shown in FIG. 31B.

FIG. 32A is a diagram for explaining the third embodiment, which is a graph showing a relationship between input power Pᵢ to the limiting-current type gas sensor and time t.

FIG. 32B is a diagram for explaining the third embodiment, which is a graph showing a relationship between a temperature T of the beam structure body and time t of integral power Es in the case of input the power Pᵢ shown in FIG. 32A.

FIG. 33 is a schematic block configuration diagram showing an example of Pt resistance measurement in the case of input the power shown in FIG. 32A.

FIG. 34 is a graph showing an example of an intermittent sampling action of the limiting-current type gas sensor according to the third embodiment.

FIG. 35A is a schematic planar pattern configuration diagram showing a micro heater of a limiting-current type gas sensor according to a fourth embodiment.

FIG. 35B is a schematic cross-sectional structure diagram taken in the IV-IV of FIG. 35A, in the limiting-current type gas sensor according to the fourth embodiment.

FIG. 36A is a schematic planar pattern configuration diagram showing a micro heater of a limiting-current type gas sensor according to a fifth embodiment.

FIG. 36B is a schematic cross-sectional structure diagram taken in the V-V of FIG. 36A, in the limiting-current type gas sensor according to the fifth embodiment.

FIG. 37 is a schematic bird's-eye view configuration diagram showing a sealing cover of a package for housing the limiting-current type gas sensor according to the first to fifth embodiments.

FIG. 38 is a schematic bird's-eye view configuration diagram showing a main unit of the package for housing the limiting-current type gas sensor according to the first to fifth embodiments.

FIG. 39 is a schematic block configuration diagram showing the limiting-current type gas sensor according to the first to fifth embodiments.

FIG. 40 is a schematic block configuration diagram of a sensor network to which the limiting-current type gas sensor according to the first to fifth embodiments is applied.

### DESCRIPTION OF EMBODIMENTS

Next, certain embodiments will be described with reference to drawings. In the description of the following drawings, the identical or similar reference numeral is attached to the identical or similar part. However, it should be noted that the drawings are schematic and the relation between thickness and the plane size and the ratio of the thickness of each component part differs from an actual thing. Therefore, detailed thickness and size should be determined in consideration of the following explanation.

Of course, the part from which the relation and ratio of a mutual size differ also in mutually drawings is included. Moreover, the embodiments described hereinafter merely exemplify the apparatus and method for materializing the technical idea; and the embodiments do not specify the material, shape, structure, placement, etc. of each component part as the following. The embodiments may be changed without departing from the spirit or scope of claims.

### First Embodiment

### Limiting-Current Type Gas Sensor

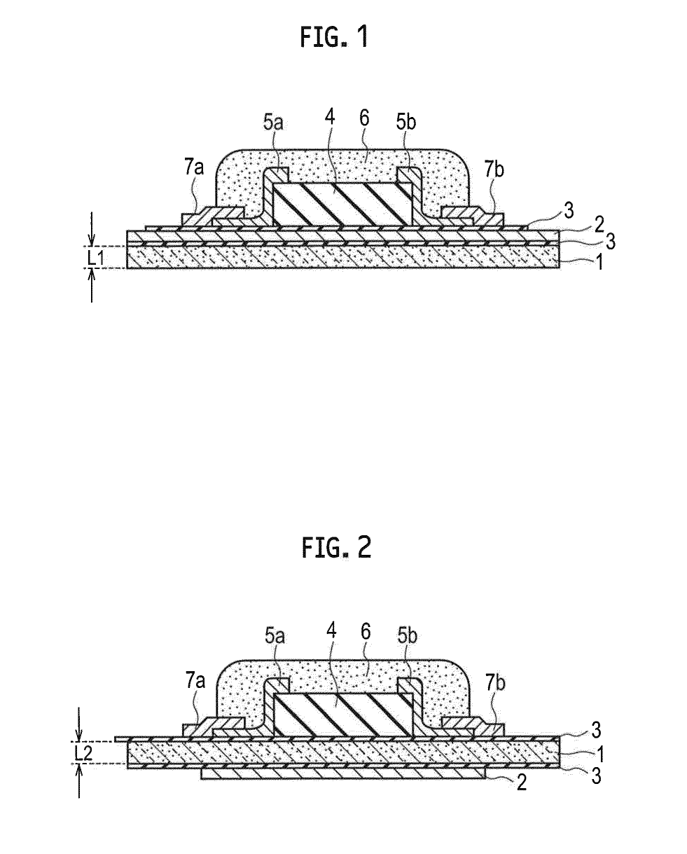

A schematic cross-sectional structure of a limiting-current type gas sensor according to the first embodiment is expressed as shown in FIG. 1. As shown in FIG. 1, the limiting-current type gas sensor according to the first embodiment includes: an Si substrate 1; a micro heater 2 formed on the Si substrate 1; a solid electrolyte layer 4 having ion conductivity formed on the Si substrate 1; a pair of positive and negative porous electrodes 5a, 5b adhesively formed on the solid electrolyte layer 4; and a detection circuit 8 (not shown in FIG. 1) configured to detect a predetermined gas density in measured gas with a limiting current method by applying voltage between the pair of the positive and negative porous electrodes 5a, 5b. A porous membrane 6 adhesively formed on the solid electrolyte layer 4 and the pair of the positive and negative porous electrodes 5a, 5b may be provided, if required.

The Si substrate 1 is, for example is a Si substrate, of which the thickness L is equal to or less than 2 μm, formed with Micro-Electro-Mechanical Systems (MEMS). It is possible to reduce power consumption in the micro heater 2 since the thickness L of the Si substrate 1 can be reduced to equal to or less than 2 μm if the MEMS is applied thereto, and thereby the heat capacity becomes small.

Moreover, the micro heater 2 is a printed Pt heater formed by printing, or polysilicon, for example. The solid electrolyte layer 4 is a printed film containing at least one of ZrO₂—Y₂O₃, SiO₂, or Al₂O₃ formed by printing, for example. The pair of the positive and negative porous electrodes 5a, 5b is porous Pt printed electrodes formed by printing, for example. The porous membrane 6 is a printed film containing at least one kind of Al₂O₃, SiO₂, MgO and an amorphous glass formed by printing, for example. The thickness of the porous membrane 6 is approximately 5 μm, for example. Reference numeral 3 shown in FIG. 1 denotes an insulating film, e.g. a printed SiO₂ film, or a printed Al₂O₃ film. In this way, if each layer is formed by printing, each layer can be easily fabricated, thereby reducing cost thereof.

Moreover, the detection circuit 8 may detect the oxygen density on the basis of a limiting current. Alternatively or in addition, a vapor density may be detected on the basis of the limiting current.

Moreover, one of the pairs of the positive and negative porous electrodes 5a, 5b may be formed on the solid electrolyte layer 4, and another thereof may be formed under the solid electrolyte layer 4. Alternatively, both of the pair of the positive and negative porous electrodes 5a, 5b may be formed on the solid electrolyte layer 4.

A schematic cross-sectional structure of another limiting-current type gas sensor according to the first embodiment is expressed as shown in FIG. 2. As shown in FIG. 2, it is also possible to form the micro heater 2 under the Si substrate 1. Such a limiting-current type gas sensor may be fabricated by methods other than MEMS. The thickness L2 of the Si substrate 1 is approximately 600 μm, for example. Other configuration is the same as that of FIG. 1.

### Comparative Example 1

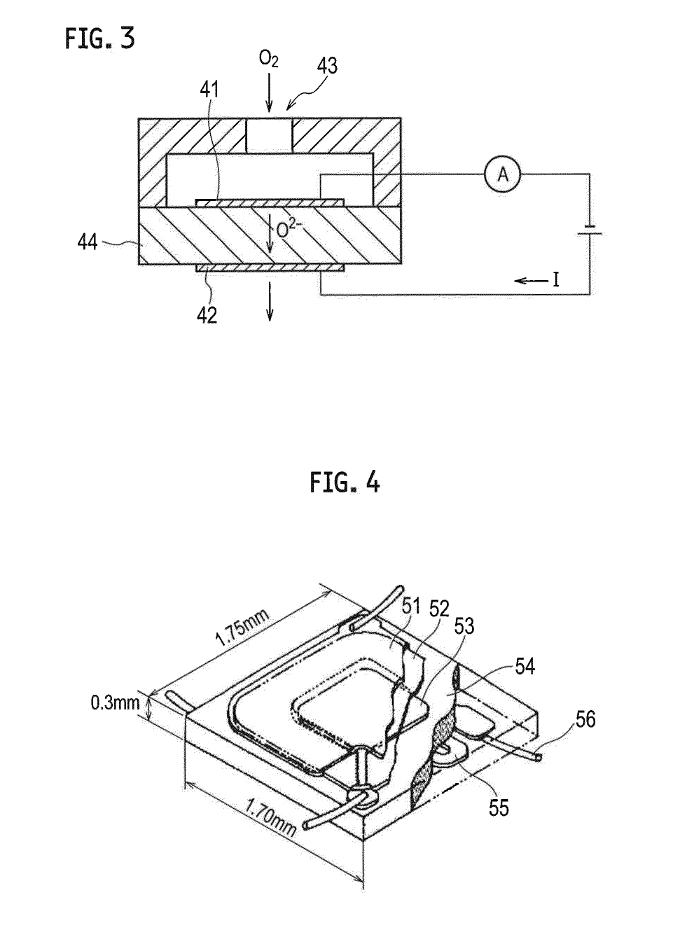

A schematic cross-sectional structure of a limiting-current type gas sensor according to a comparative example 1 is expressed as shown in FIG. 3. As shown in FIG. 3, platinum electrodes 41, 42 are attached to an upper and lower surfaces of the zirconia electrolyte 44, and a current I is passed therethrough. If the cathode 41 is covered with a cover in which a small hole 43 is formed, an amount of oxygen transport to the cathode 41 will almost be dominated by oxygen gas diffusion of a portion of the small hole 43. As a result, an oxygen ion flow rate which flows through the zirconia electrolyte 44, i.e., the current I, is approximately determined in accordance with an amount of oxygen gas diffusing at the small hole 43. In this way, the oxygen to the cathode 41 is supplied by gas diffusion, and thereby detecting a limiting current in proportion to the oxygen density.

A schematic bird's-eye view configuration of another limiting-current type gas sensor according to the comparative example 1 is expressed as shown in FIG. 4. As shown in FIG. 4, each thin film of a platinum electrode (cathode) 53, a zirconia electrolyte 52, and a platinum electrode (anode) 51 is laminated one after another on the whole surface of a porous alumina substrate 54 of which a pore size of 800 angstroms, in order to be formed as an oxygen gas detection unit. A platinum thin-film heater 55 is disposed in another whole surface, and then lead wires 56 is respectively extracted from four corners. The size of the thin-film limiting-current type oxygen sensor with a heater fabricated in this way is 1.70 mm×1.75 mm×0.30 mm.

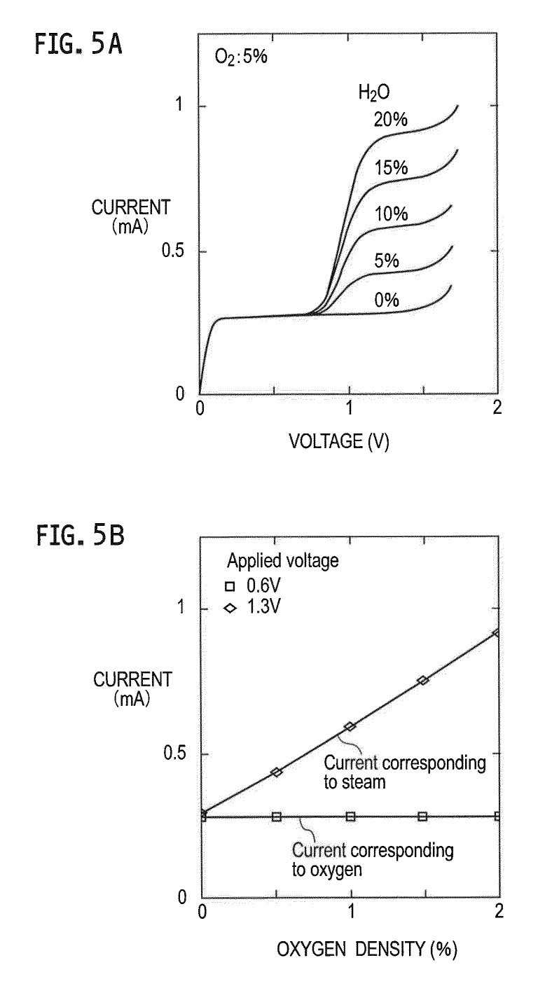

Current-voltage characteristics of the limiting-current type gas sensor according to the comparative example 1 are expressed as shown in FIG. 5A, and current-oxygen density characteristics thereof are expressed as shown in FIG. 5B. More specifically, a large amount of a vapor (H₂O) and carbon dioxide (CO₂) are contained in atmosphere as combustion exhaust gas. In order to clarify effect on the limiting current due to the gases, there is shown a result of having measured sensor characteristics in O₂—N₂ mixed gases to which various densities of H₂O and/or CO₂ are added.

If H₂O exists as shown in FIG. 5A, a voltage width in which the limiting current corresponding to the oxygen appears (overvoltage-dominant region) becomes narrow up to approximately 0.7V. If exceeding the aforementioned voltage, the current is increased again, and then a second-stage saturation current will appear. As a result, the gas containing O₂ and H₂O has two stages of saturation current characteristics. A magnitude of the second-stage saturation current linearly increases in correspondence with the H₂O density, as shown in FIG. 5B. Moreover, a magnitude of current at the first stage, i.e., the limiting current of the oxygen, is not affected by the H₂O density.

### Comparative Example 2

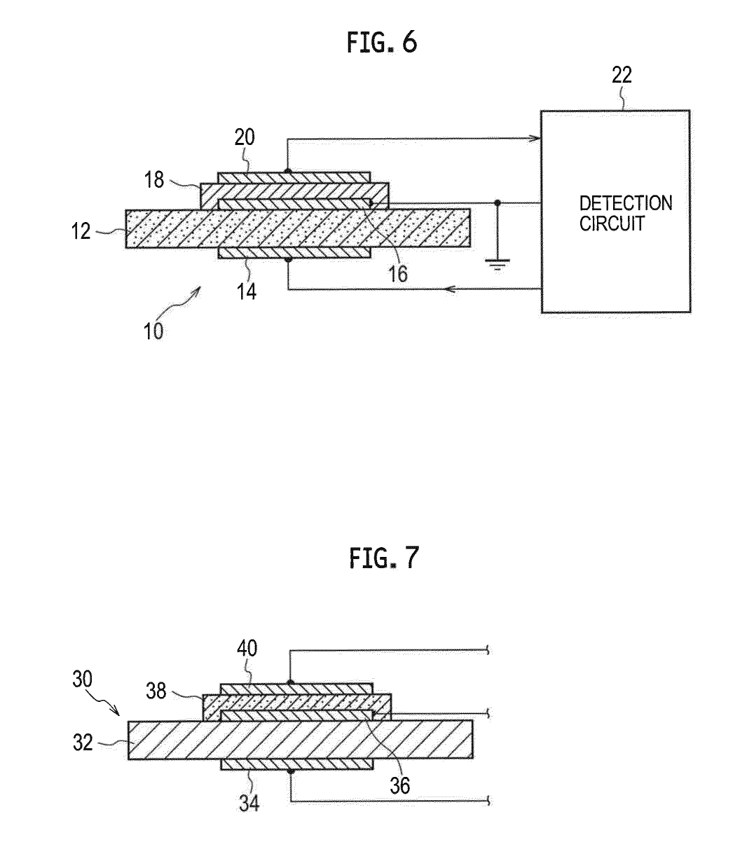

A schematic cross-sectional structure of a limiting-current type gas sensor 10 according to a comparative example 2 is expressed as shown in FIG. 6. As shown in FIG. 6, an electrode 16 is provided between a zirconia substrate 12 and a zirconia film 18, an electrode 14 is provided under the zirconia substrate 12, and an electrode 20 is provided on the zirconia film 18. An amount of oxygen transport is limited by the zirconia substrate 12. In a state where the limiting-current type gas sensor 10 is heated by a heater, the current I is passed in a direction of the arrow, and the oxygen density is detected in a detection circuit 22.

A schematic cross-sectional structure of another limiting-current type gas sensor 30 according to the comparative example 2 is expressed as shown in FIG. 7. As shown in FIG. 7, an electrode 36 is provided between a zirconia film 32 and a zirconia substrate 38, an electrode 34 is provided under the zirconia film 32, and an electrode 40 is provided on the zirconia substrate 38. An amount of oxygen transport is limited by the zirconia substrate 38. In a state where the limiting-current type gas sensor 30 is heated by a heater, the current I is passed in a direction of the arrow, and the oxygen density is detected in a detection circuit 22.

### Comparative Example 3

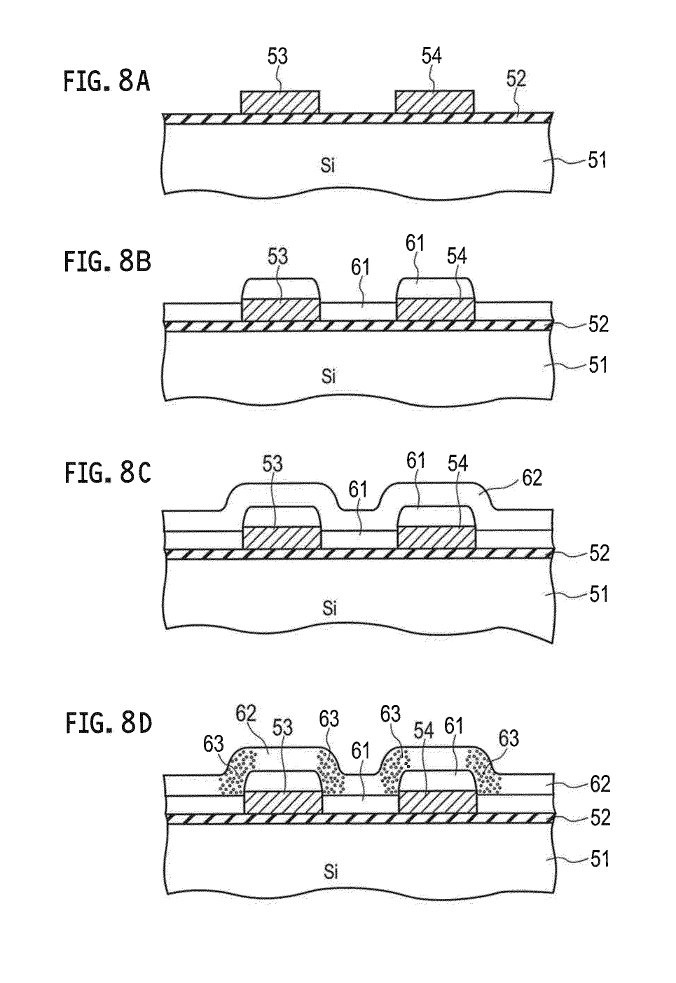

A fabrication method of a limiting-current type gas sensor according to a comparative example 3 is expressed as shown in FIG. 8. Firstly, as shown in FIG. 8A, approximately 100-nm silicon oxide film 52 is formed on a silicon substrate 51, and then an anode electrode 53 and a cathode electrode 54 formed of a Pt film are formed on the silicon oxide film 52. The film thickness of the anode electrode 53 and cathode electrode 54 is 400 nm. Next, as shown in FIG. 8B, an ionic conductor film 61 composed of ZrO₂—Y₂O₃ is formed on the entire substrate. The film thickness of the ionic conductor film 61 is 300 nm, and is thinner than that of the electrodes 53, 54. Accordingly, the ionic conductor film 61 is in a state where a part of the ionic conductor film 61 embedded between the electrodes 53, 54 to actually function as an ionic conductor, and a part of the ionic conductor film 61 laminated on the electrodes 53, 54 are separated to each other, as shown in FIG. 8B. Next, as shown in FIG. 8C, a Zr—Y film 62 with the thickness of 400 nm is formed thereon. Finally, an anodization is performed by applying positive voltage to the anode electrode 53 and the cathode electrode 54 using H₃PO₄ aqueous solution. Thereby, as shown in FIG. 8D, a gas diffusion layer 63 composed of porous ZrO₂—Y₂O₃ is formed, centering on a portion corresponding to an edge portion of the electrodes 53, 54 of the Zr—Y film. 62 directly contacted with the electrodes 53, 54.

### (Detecting Operation)

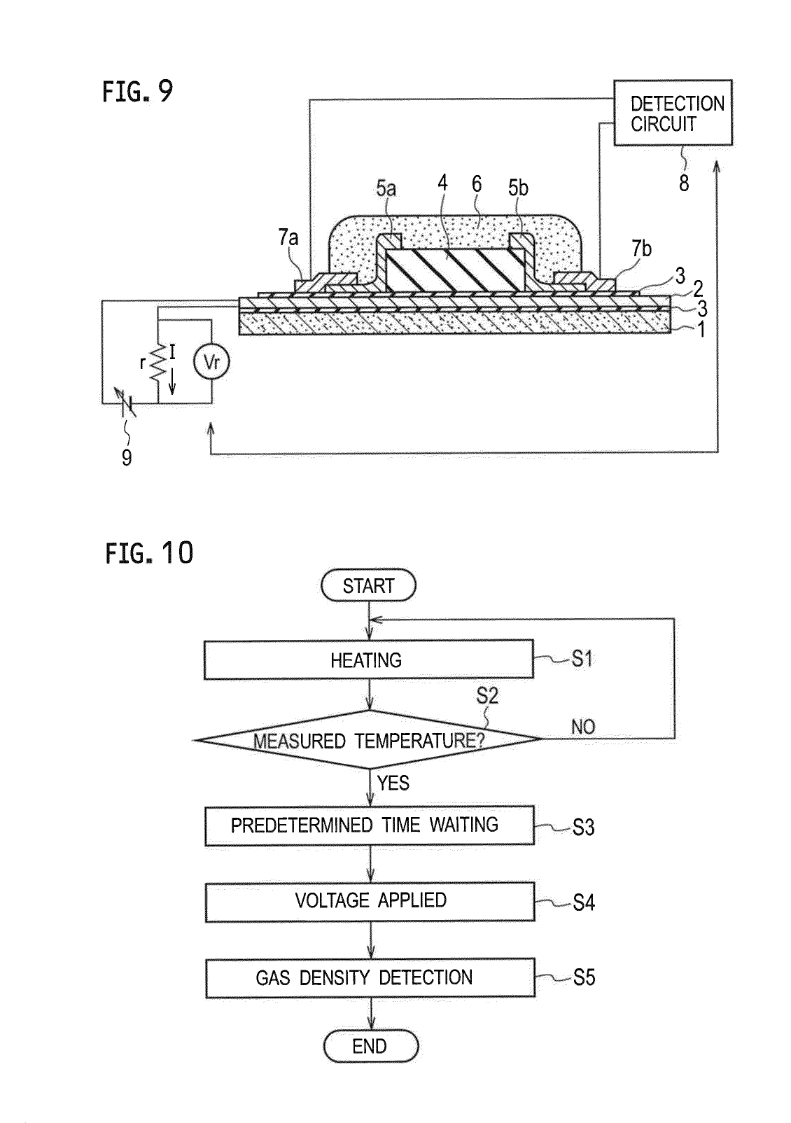

A schematic block configuration in the case of detecting gas density using the limiting-current type gas sensor according to the first embodiment is expressed as shown in FIG. 9. As shown in FIG. 9, a pair of the positive and negative porous electrodes 5a, 5b is respectively provided in the right and left surfaces of the solid electrolyte layer 4, and is connected to the detection circuit 8 through pad electrodes 7a, 7b. If the solid electrolyte layer 4 is heated up to approximately 700 degrees C., and then the voltage is applied to the porous electrodes 5a, 5b to pass the current I, oxygen ion is injected into the solid electrolyte layer 4 by electrochemical reaction with O₂+4e→2O₂, in the cathode 5a. On the other hand, oxygen is released by a reaction with 2O₂⁻→O₂+4e, in the anode 5b.

If an amount of oxygen gas inhaled to the electrolyte 4 using the porous membrane 6 is limited at that time, saturation phenomena in which a current becomes constant value will appear even if the voltage is increased. Since the limiting current is proportional to surrounding oxygen density, a value of the limiting current is previously associated with a value of the oxygen density to be registered into the detection circuit 8. Thus, the oxygen density corresponding to a value of the limiting current can be detected by measuring the value of the limiting current.

Moreover, a resistance value of the resistor r is expressed with Vin/I=Vin×r/Vr, where Vin is a power supply voltage of a power supply 9 to, sets to I is a current flowing into the resistor r, and Vr is voltage applied to the resistor r. Temperature measured on the basis of the resistance value of the resistor r, may be fed back to the detection circuit 8, and then voltage V applied between the porous electrodes 5a, 5b may be switched. If the voltage V applied between the porous electrodes 5a, 5b is switched in this way, it is possible to detect not only the oxygen density but also the vapor density.

An operation for detecting the gas density using the limiting-current type gas sensor shown in FIG. 9 is expressed as shown in FIG. 10. Firstly, the sensor is heated up to measured temperature (e.g., 700 degrees C.) using the micro heater 2 (Step S1→S2: NO→S1→ . . . ). If the temperature of the sensor reaches the measured temperature (Step S2: YES), the voltage is applied between the porous electrodes 5a, 5b after waiting for predetermined time until it is stabilized (step S3→S4). Accordingly, the gas density corresponding to the limiting current can be detected by measuring the value of the limiting current (Step S5). It is possible to detect both of the oxygen density and the vapor density by switching the voltage applied between the porous electrodes 5a, 5b.

### Concrete Example

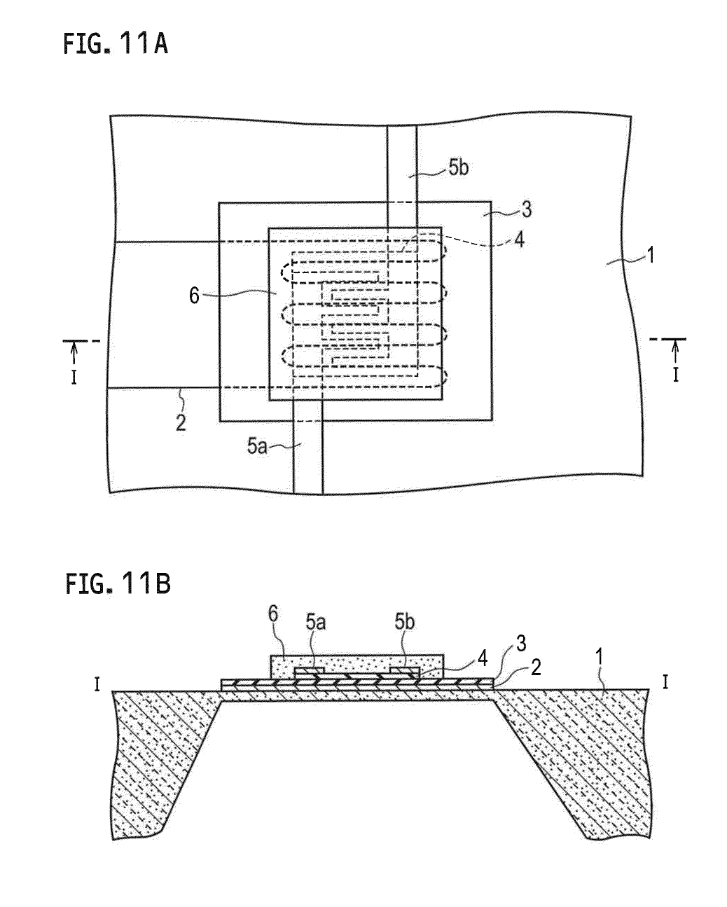

A schematic planar pattern configuration of the limiting-current type gas sensor according to the first embodiment is expressed as shown in FIG. 11A. A schematic cross-sectional structure taken in the line I-I of FIG. 11A is expressed as shown in FIG. 11B. As shown in FIGS. 11A and 1B, the micro heater 2 is disposed in a zigzag direction, in a planar view, under the rectangular-shaped solid electrolyte layer 4 via the insulating film 3. Moreover, a pair of the positive and negative porous electrodes 5a, 5b is formed in a comb-shaped pattern to be disposed face to face with each other. The porous electrode 5a is extracted from one side (upper side in FIG. 11A), and the porous electrode 5b is extracted from another side (lower side in FIG. 11A). The porous membrane 6 is formed in a rectangle shape, in a planar view, and covers the solid electrolyte layer 4 and the pair of the positive and negative porous electrodes 5a, 5b. Needless to say, a shape, a size, etc. of each layer can be appropriately changed.

### (Fabrication Method)

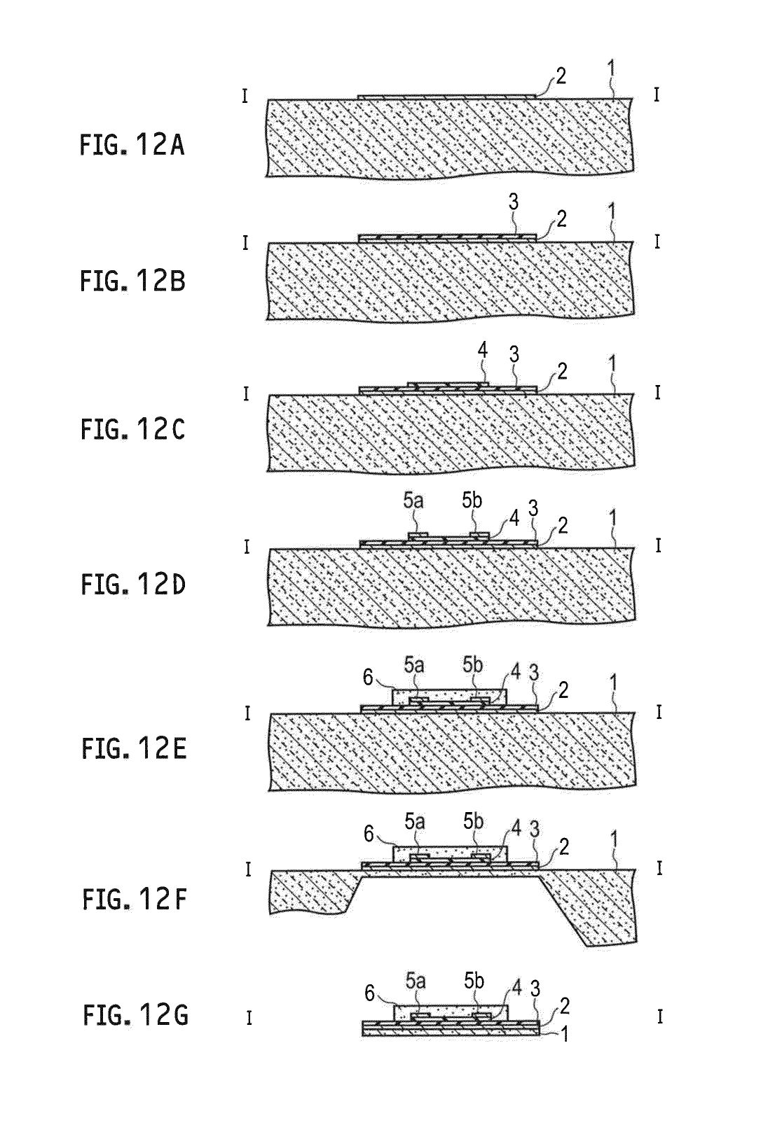

As shown in FIG. 12, a fabrication method of the limiting-current type gas sensor according to the first embodiment includes: forming the Si substrate 1; forming the micro heater 2 on the Si substrate 1 (or under the Si substrate 1); forming the solid electrolyte layer 4 having ion conductivity on the Si substrate 1; and adhesively forming the pair of the positive and negative porous electrodes 5a, 5b to the solid electrolyte layer 4. The fabrication method may include adhesively forming the porous membrane 6 on the solid electrolyte layer 4 and the pair of the positive and negative porous electrodes 5a, 5b, if required. In the embodiment, MEMS can be applied since the Si substrate 1 is used. Hereinafter, these processes will now be explained in more detail with reference to FIG. 12.

Firstly, as shown in FIG. 12A, Pt is printed on the Si substrate 1, thereby forming the micro heater 2. More specifically, Pt paste is coated on the Si substrate 1 by using a screen printer. Polysilicon instead of Pt may be formed on the Si substrate 1.

Next, as shown in FIG. 12B, SiO₂ or Al₂O₃ is printed on the micro heater 2, thereby forming the insulating film 3.

Next, as shown in FIG. 12C, at least ZrO₂—Y₂O₃, SiO₂, or Al₂O₃ is printed on the insulating film 3, thereby forming the solid electrolyte layer 4.

Next, as shown in FIG. 12D, Pt is printed thereon, thereby forming the pair of the positive and negative porous electrodes 5a, 5b.

Next, as shown in FIG. 12E, at least one kind of Al₂O₃, SiO₂, MgO, and an amorphous glass are printed on the solid electrolyte layer 4 and the pair of the positive and negative porous electrodes 5a, 5b, thereby forming the porous membrane 6. Annealing is performed for each process. In order to prevent film crack and/or peeling from occurring, another kind of particles are mixed into each layer to control coefficient of thermal expansion, as required.

Finally, as shown in FIG. 12F, the Si substrate 1 is reduced in thickness to be equal to or less than 2 μm through anisotropic etching using KOH aqueous solution etc.

In addition, as shown in FIG. 12G, after the process of FIG. 12F, the portion of which the thickness is reduced of the Si substrate 1 may be cut out. Accordingly, the cut-out thin-type sensor chip can also be laminated on another substrate to be packaged.

### Modified Example

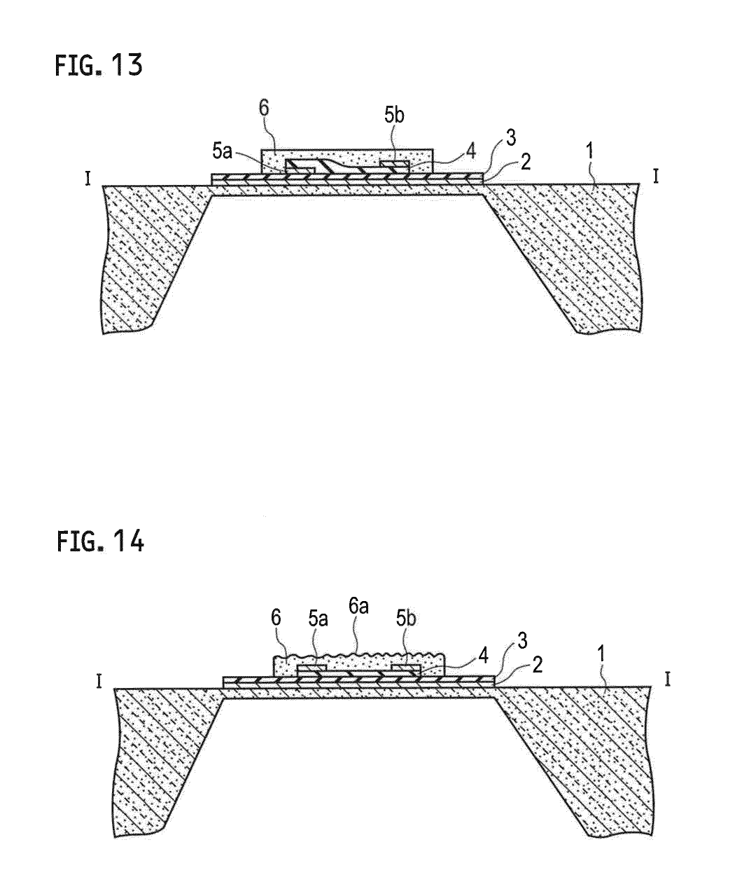

A schematic cross-sectional structure showing a modified example of the limiting-current type gas sensor according to the first embodiment is expressed as shown in FIG. 13. A different point from FIG. 11B is a point that the pair of the positive and negative porous electrodes 5a, 5b is formed in a vertical direction. More specifically, as shown in FIG. 11B, both of the pairs of the positive and negative porous electrodes 5a, 5b may also be formed on the solid electrolyte layer 4. Alternatively, as shown in FIG. 13, one of the pairs of the positive and negative porous electrodes 5a, 5b may be formed on the solid electrolyte layer 4, and another thereof may be formed under the solid electrolyte layer 4.

A schematic cross-sectional structure showing another modified example of the limiting-current type gas sensor according to the first embodiment is expressed as shown in FIG. 14. A different point from FIG. 11B is a point that roughness is formed on the surface 6a of the porous membrane 6. More specifically, after forming the porous membrane 6, a surface roughening process may be applied to the surface 6a thereof. Thus, a contact area with measured gas is increased as the roughness is formed on the surface 6a of the porous membrane 6, and thereby the surface area of the porous membrane 6 is also increased.

As mentioned above, according to the first embodiment, the thickness of Si substrate 1 can be reduced up to equal to or less than 2 μm since the MEMS can be applied thereto. Accordingly, it is possible to reduce the power consumption used in the micro heater 2, since the heat capacity becomes smaller than that of the comparative example. Moreover, it is possible to reduce the cost since the porous substrate as used in the comparative example is not required. Furthermore, since each layer is formed by printing, the process of anodization as used in the comparative example is unnecessary, and therefore the fabrication is easy. Needless to say, the limiting-current type sensor using zirconia thin film has also an effect of having high reliability and sufficient linearity.

### Second Embodiment

### Limiting-Current Type Gas Sensor

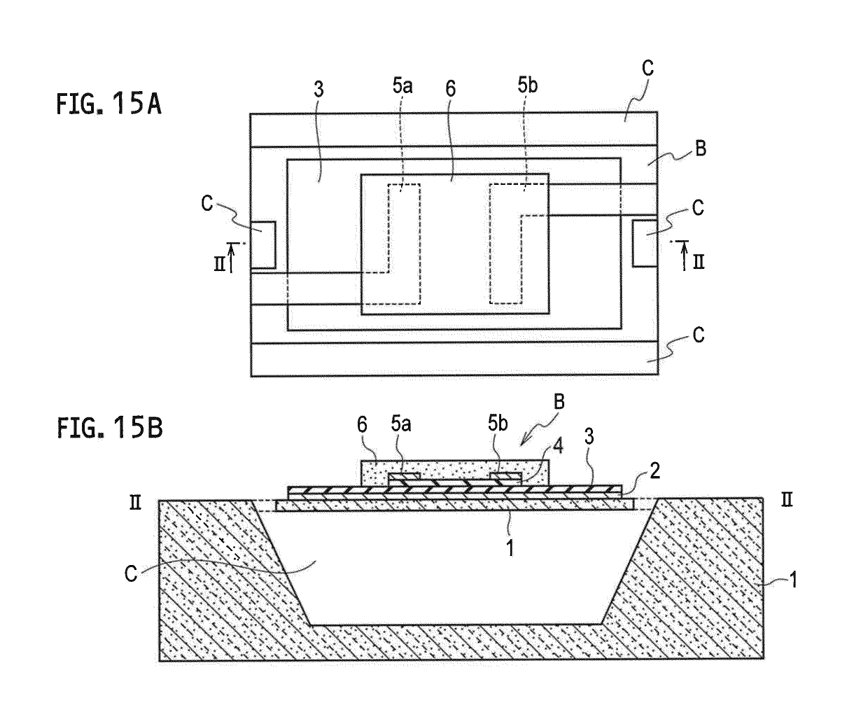

A schematic planar pattern configuration of the limiting-current type gas sensor according to a second embodiment is expressed as shown in FIG. 15A. Moreover, a schematic cross-sectional structure taken in the line II-II of FIG. 15A is expressed as shown in FIG. 15B. As shown in FIGS. 15A and 15B, the limiting-current type gas sensor according to the second embodiment is formed as a both-ends-supported beam structure body (straddle-mounted beam structure) B on the cavity C formed in the Si substrate 1. The beam structure body B is a beam structure body, of which the thickness is equal to or less than 2 μm, formed of MEMS, for example.

A configuration of the beam structure body B is the same as that of the limiting-current type gas sensor according to the first embodiment. More specifically, the beam structure body B includes: an Si substrate 1; a micro heater 2 formed on the Si substrate 1; a solid electrolyte layer 4 having ion conductivity formed on the Si substrate 1; a pair of positive and negative porous electrodes 5a, 5b adhesively formed on the solid electrolyte layer 4; and a porous membrane 6 adhesively formed on the solid electrolyte layer 4 and the pair of the positive and negative porous electrodes 5a, 5b. A point of not necessarily include the porous membrane 6 is as explained in the first embodiment.

### (Fabrication Method)

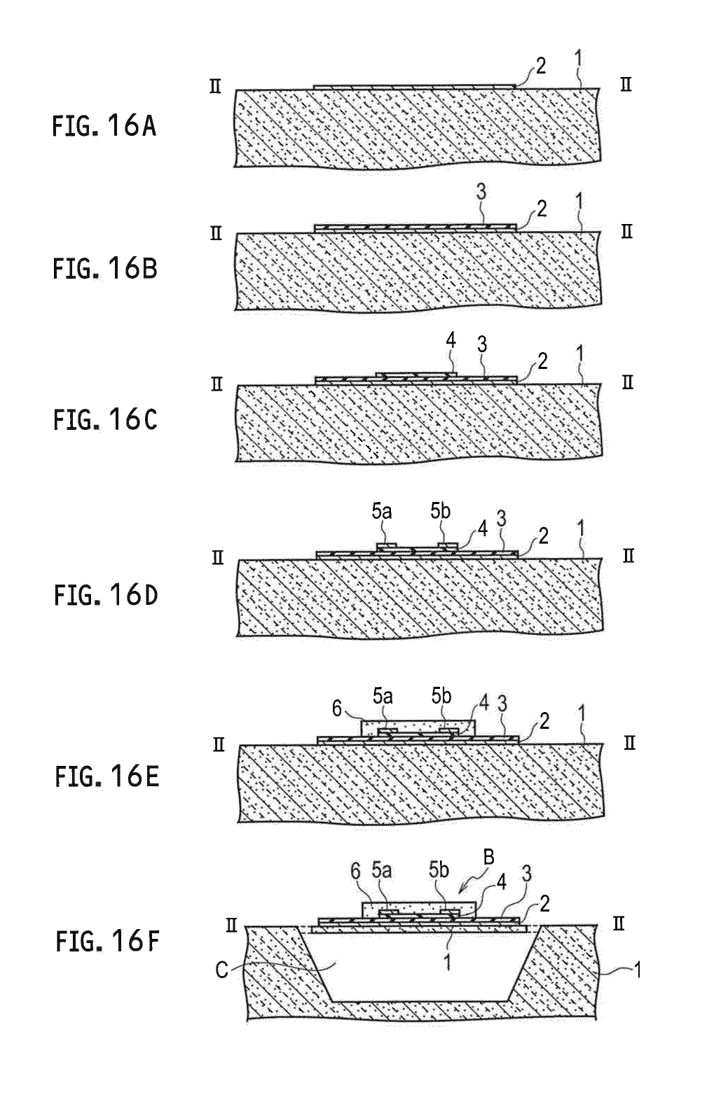

A fabrication method of the limiting-current type gas sensor according to the second embodiment is expressed as shown in FIG. 16. As shown in FIGS. 16A-16E, the process until the porous membrane 6 is formed is the same as that of the first embodiment. More specifically, as shown in FIG. 16A, Pt or polysilicon is printed on the Si substrate 1, thereby forming the micro heater 2. Next, as shown in FIG. 16B, SiO₂ or Al₂O₃ is printed on the micro heater 2, thereby forming the insulating film 3. Next, as shown in FIG. 16C, at least ZrO₂—Y₂O₃, SiO₂, or Al₂O₃ is printed on the insulating film 3, thereby forming the solid electrolyte layer 4. Next, as shown in FIG. 16D, Pt is printed thereon, thereby forming the pair of the positive and negative porous electrodes 5a, 5b. Next, as shown in FIG. 16E, at least one kind of Al₂O₃, SiO₂, MgO, and an amorphous glass are printed on the solid electrolyte layer 4 and the pair of the positive and negative porous electrodes 5a, 5b, thereby forming the porous membrane 6.

In the second embodiment, as shown in FIG. 16F, the cavity C is formed in portions directly under the micro heater 2 etc., in the Si substrate 1. Such a cavity C is formed by performing anisotropic etching of the Si substrate 1 using TMAH solution, for example. Accordingly, the limiting-current type gas sensor can be formed as the both-ends-supported beam structure body B on the cavity C.

### Modified Example

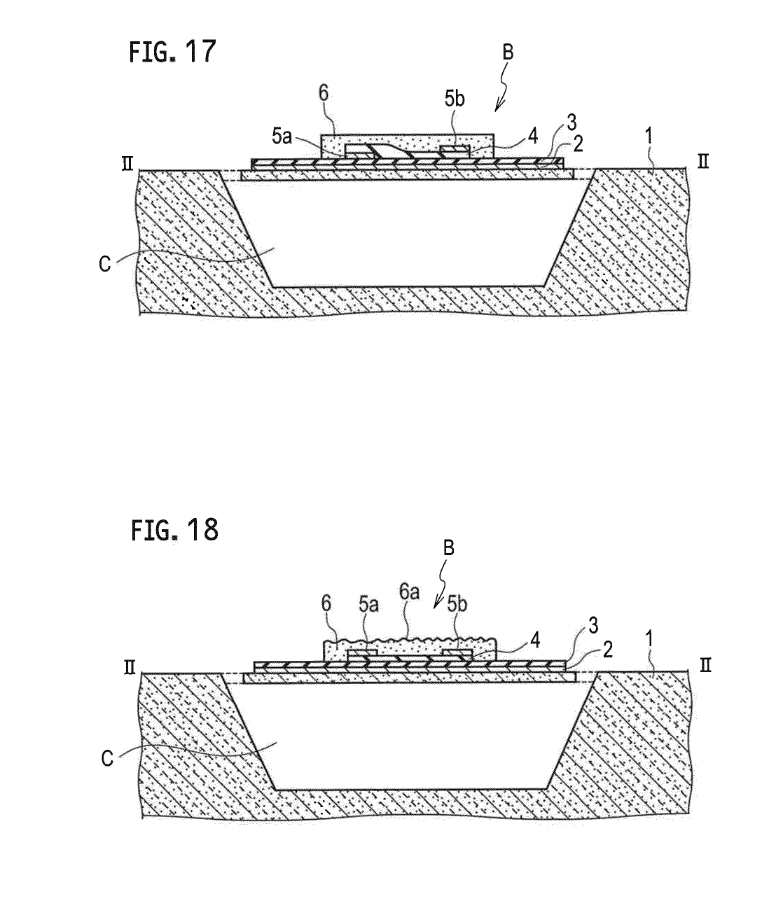

A schematic cross-sectional structure showing a modified example of the limiting-current type gas sensor according to the second embodiment is expressed as shown in FIG. 17. A different point from FIG. 15B is a point that the pair of the positive and negative porous electrodes 5a, 5b is formed in a vertical direction. More specifically, as shown in FIG. 15B, both of the pairs of the positive and negative porous electrodes 5a, 5b may also be formed on the solid electrolyte layer 4. Alternatively, as shown in FIG. 17, one of the pairs of the positive and negative porous electrodes 5a, 5b may be formed on the solid electrolyte layer 4, and another thereof may be formed under the solid electrolyte layer 4.

A schematic cross-sectional structure showing another modified example of the limiting-current type gas sensor according to the second embodiment is expressed as shown in FIG. 18. A different point from FIG. 15B is a point that roughness is formed on the surface 6a of the porous membrane 6. More specifically, after forming the porous membrane 6, a surface roughening process may be applied to the surface 6a thereof. Thus, a contact area with measured gas is increased as the roughness is formed on the surface 6a of the porous membrane 6, and thereby the surface area of the porous membrane 6 is also increased.

As mentioned above, the limiting-current type gas sensor according to the second embodiment is formed as a both-ends-supported beam structure body (straddle-mounted beam structure) B on the cavity C formed in the Si substrate 1. According to such beam structure, even if the sensor is disposed on a printed circuit board etc., it is effective in that the heat is hardly transferred from the sensor to transfer to the printed circuit board.

### Third Embodiment

### Limiting-Current Type Gas Sensor

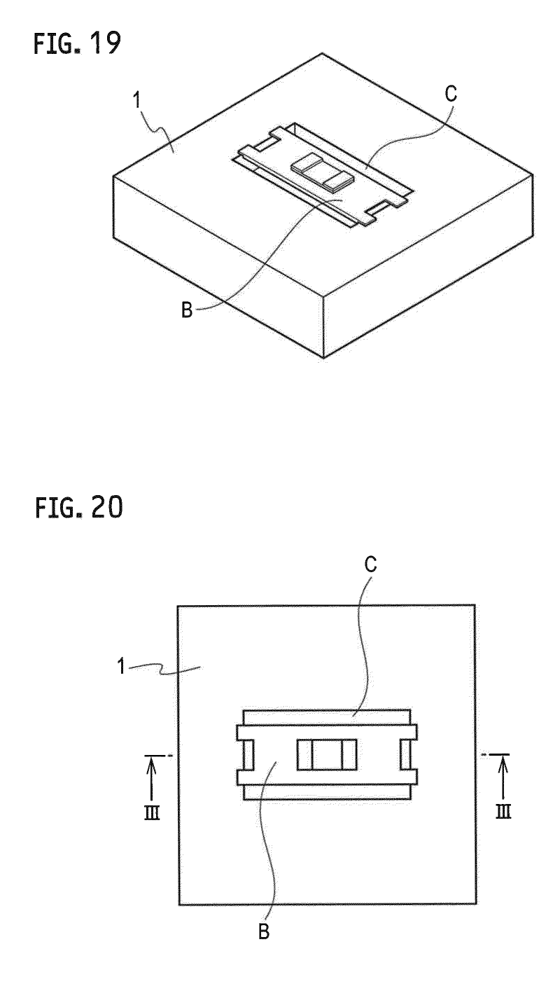

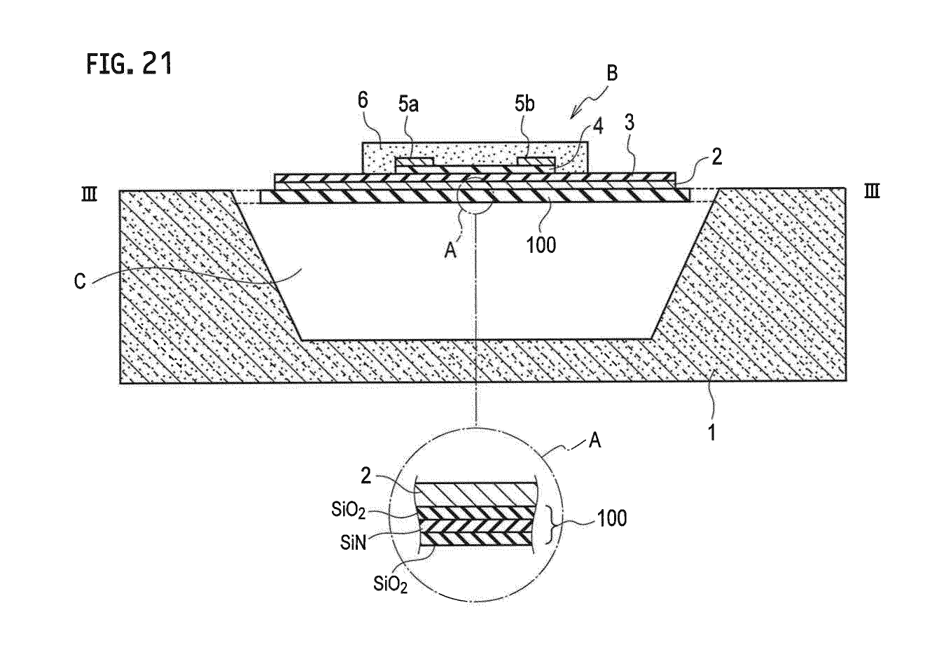

A schematic bird's-eye view configuration of a limiting-current type gas sensor according to the third embodiment is expressed as shown in FIG. 19. Moreover, a schematic planar pattern configuration of the limiting-current type gas sensor shown in FIG. 19 is expressed as shown in FIG. 20. Moreover, a schematic cross-sectional structure taken in the line III-III of FIG. 20 is expressed as shown in FIG. 21. As shown in FIGS. 19-21, the limiting-current type gas sensor according to the third embodiment is also formed as a both-ends-supported beam structure body (straddle-mounted beam structure) B on the cavity C formed in the Si substrate 1. A different point from the second embodiment (FIG. 15) is a point that a supporting unit 100 of the beam structure body B is a multilayered insulating film composed of SiO₂ and SiN. Specifically, the aforementioned multilayered insulating film is a multilayered insulating film composed of SiO₂/SiN/SiO₂, as shown in the circle A in FIG. 21. Such a multilayered insulating film is excellent in an adhesibility with the micro heater 2. Since the thermal expansion coefficient is close to metals of the micro heater 2, it is hard to generate a thermal stress.

### (Size of Heated Portion and Transient Response of Temperature)

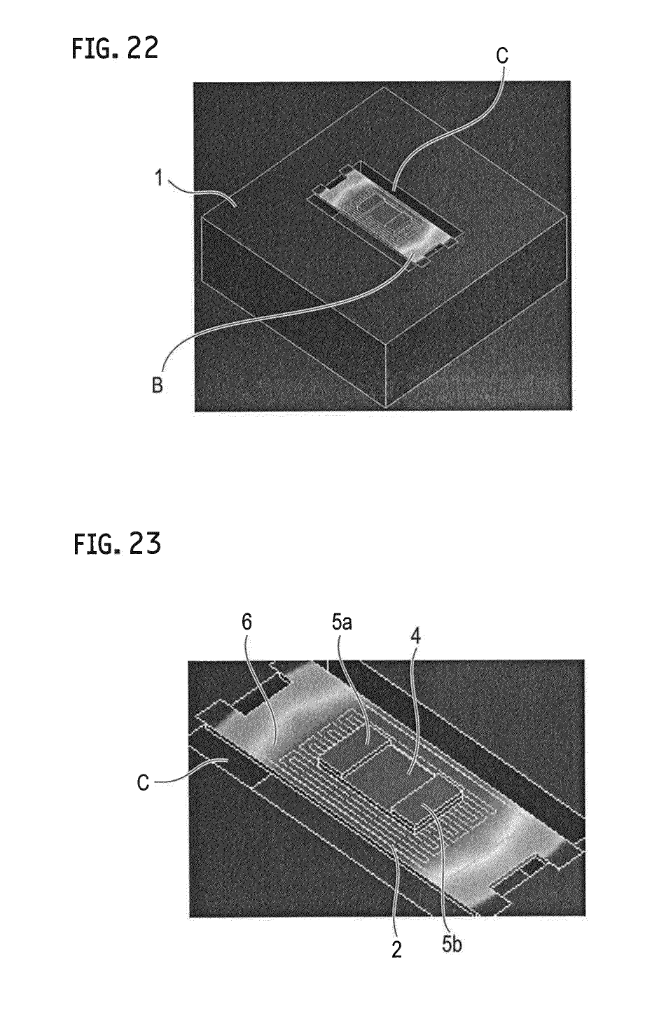

A schematic bird's-eye view configuration showing a state where the beam structure body B in the limiting-current type gas sensor according to the third embodiment is heated is expressed as shown in FIG. 22. Moreover, a schematic bird's-eye view configuration enlarging portion of the beam structure body B shown in FIG. 22 is expressed as shown in FIG. 23. As shown in FIGS. 22 and 23, a center portion of the beam structure body B becomes higher temperature with the heat generated from the micro heater 2. Even in this case, the Si substrate 1 is hardly subject to the effect due to the heating processing since the cavity C is formed in the portion directly under the beam structure body B. In the following explanation, the portion heated by the micro heater 2 of the beam structure bodies B may be referred to as “heated portion B1.”

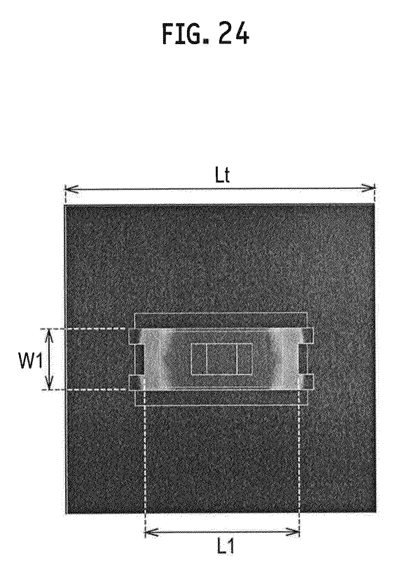

A diagram for explaining the size of the beam structure body B shown in FIG. 22 is expressed as shown in FIG. 24. As shown in FIG. 24, the Si substrate 1 is a substantially square in a planar view, and the length Lt of one side is approximately 1 mm. On the other hand, the width W1 of the beam structure body B is approximately 0.2 mm, the length L1 of the beam structure body B is approximately 0.5 mm, and the area of the beam structure body B is approximately 0.1 mm². Hereinafter, a result of a simulation using such a 0.1-mm² beam structure body B will now be explained.

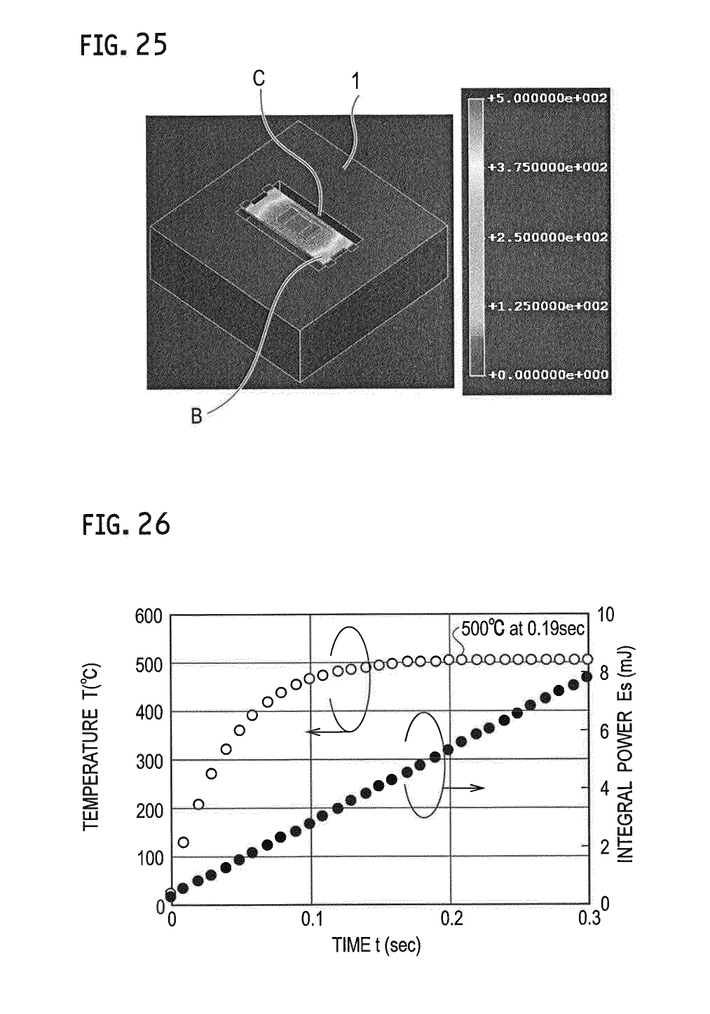

A schematic bird's-eye view configuration showing a state where the beam structure body B of the limiting-current type gas sensor according to the third embodiment is heated at 25 mW is expressed as shown in FIG. 25. There is shown an aspect that a center portion of the beam structure body B reach 500 degrees C. with the heat from the micro heater 2.

A graph showing a relationship between the temperature T (degrees C) of the beam structure body B and time t (sec) of integral power Es (mJ) in the case of heating the beam structure body B shown in FIG. 25 at 25 mW is expressed as shown in FIG. 26. The white circle plot denotes the temperature T and the black circle plot denotes the integral power Es. According to an ordinary electric power inputting method, as shown in FIG. 26, approximately 0.19 second required for heating the sensor up to the measured temperature (e.g., 500 degrees C.) using the micro heater 2, and the required integral power Es is approximately 5 mJ. Accordingly, if the limiting-current type gas sensor is applied to autonomous power-supply type sensor networks etc., it is preferred to further save the power.

(Power-Saving with Heater Power Profile)

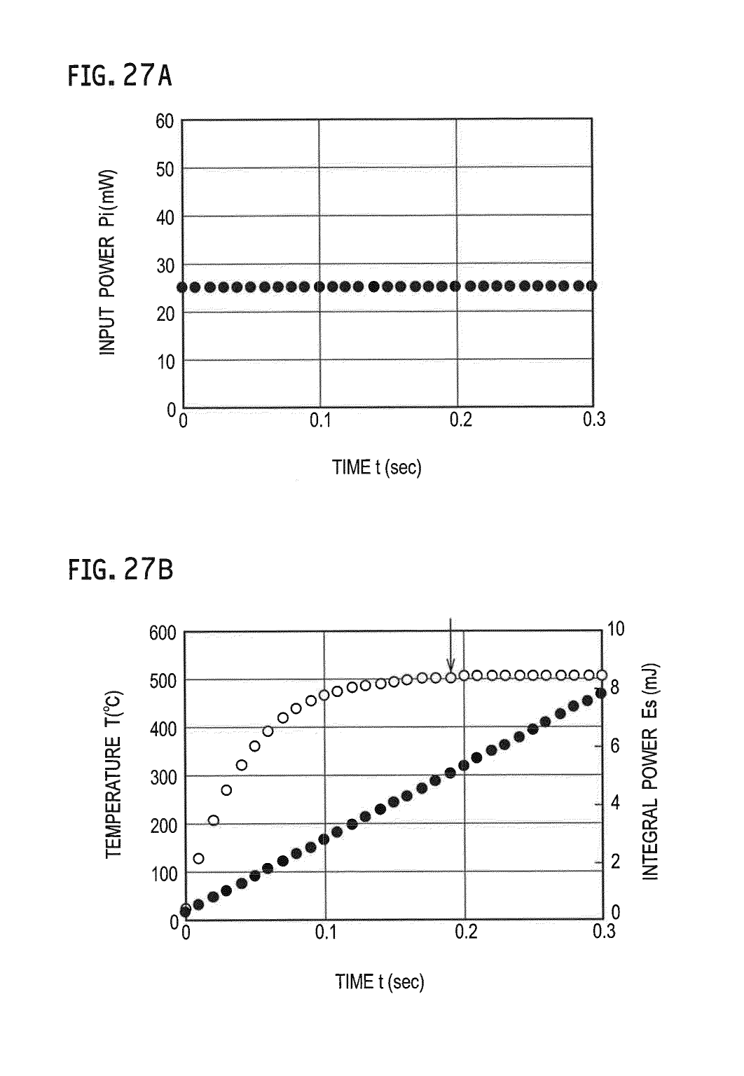

A graph showing a relationship between the input power Pᵢ (mW) to the limiting-current type gas sensor according to the comparative example and time t (sec) is expressed as shown in FIG. 27A. A graph showing a relationship between the temperature T (degrees C) of the beam structure body B and time t (sec) of the integral power Es (mJ) in the case of input the power Pᵢ shown in FIG. 27A is expressed as shown in FIG. 27B. If 25-mW constant input power Pᵢ is continued to be input as shown in FIG. 27A, the temperature T reach 500 degrees C. in approximately 0.19 second, and the required integral power Es is approximately 5 mJ, as shown in FIG. 27B.

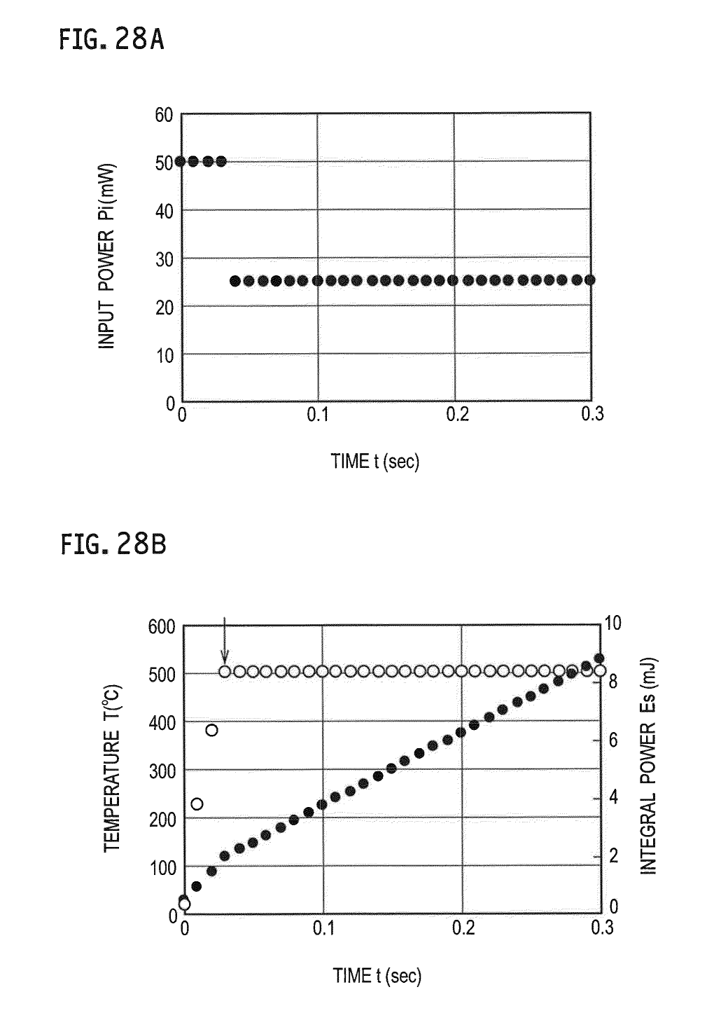

A graph showing a relationship between the input power Pᵢ (mW) to the limiting-current type gas sensor according to the third embodiment and time t (sec) is expressed as shown in FIG. 28A. A graph which shows a relationship between the temperature T (degrees C) of the beam structure body B and time t (sec) (sec) of the integral power Es (mJ) in the case of inputting the input power Pᵢ shown in FIG. 28A is expressed as shown in FIG. 28B. If 20-mW input power Pᵢ is input as shown in FIG. 28A, the temperature T reach 500 degrees C. in approximately 0.03 second, and the required integral power Es is approximately 2 mJ, as shown in FIG. 28B.

(Natural Cooling after Heating Process)

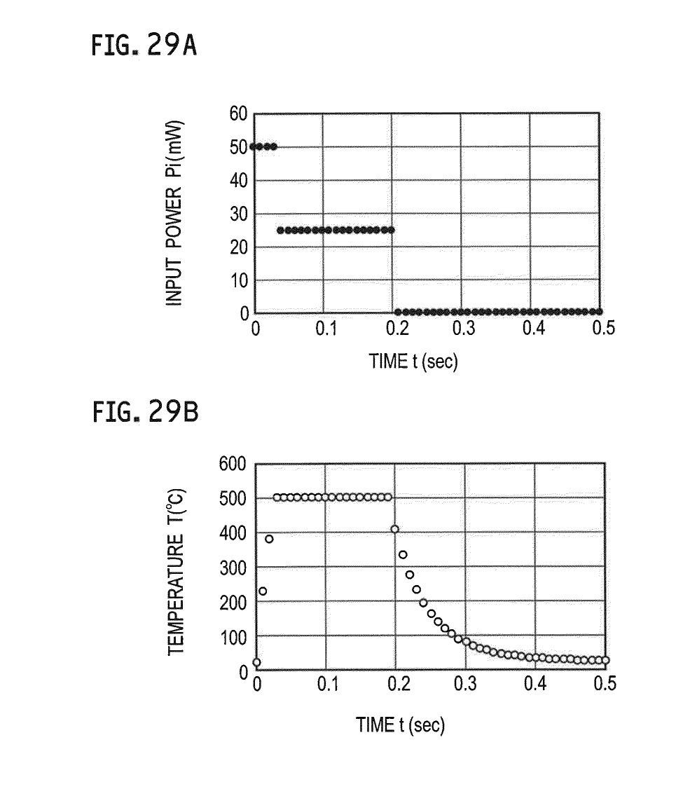

A graph showing a relationship between the input power Pᵢ (mW) to the limiting-current type gas sensor according to the third embodiment and time t (sec) is expressed as shown in FIG. 29A. A graph showing a relationship between the temperature T (degrees C) of the beam structure body B and time t (sec) in the case of inputting the input power Pᵢ shown in FIG. 29A is expressed as shown in FIG. 29B. As shown in FIG. 29A, when the time t elapses for 0.2 second, the micro heater 2 is turned OFF to stop the input of the electric power. In this case, the temperature T which is 500 degrees C. when time t elapses for 0.2 second is naturally cooled up to the initial temperature when the time t elapses approximately 0.5 second, as shown in FIG. 29B.

### (Temperature Transient Response on Printed Circuit Board)

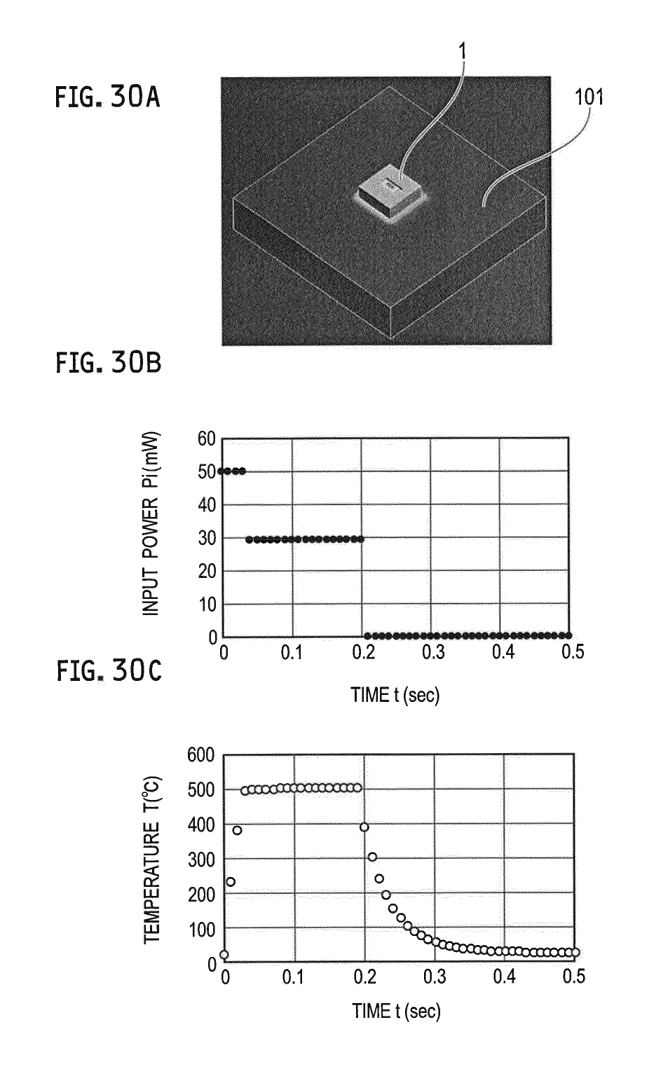

A schematic bird's-eye view configuration showing a state where the limiting-current type gas sensor according to the third embodiment is mounted on a printed circuit board 101 is expressed as shown in FIG. 30A. Moreover, a graph showing the power Pᵢ input to the limiting-current type gas sensor shown in FIG. 30A is expressed as shown in FIG. 30B. Moreover, a graph showing a relationship between the temperature T (degrees C) of the beam structure body B and time t (sec) in the case of inputting the input power Pᵢ shown in FIG. 30B is expressed as shown in FIG. 30C. As shown in FIG. 30A, the Si substrate 1 of the limiting-current type gas sensor is mounted on the printed circuit board 101. A value of an epoxy resin is used for a physical property value of the printed circuit board 101. In this case, if 29-mW input power Pᵢ is input after the 50-mW input power Pᵢ is input only for 0.03 second as shown in FIGS. 30B and 30C, it will be stabilized at 500 degrees C.

### (Temperature Transient Responses of Si Substrate and Printed Circuit Board)

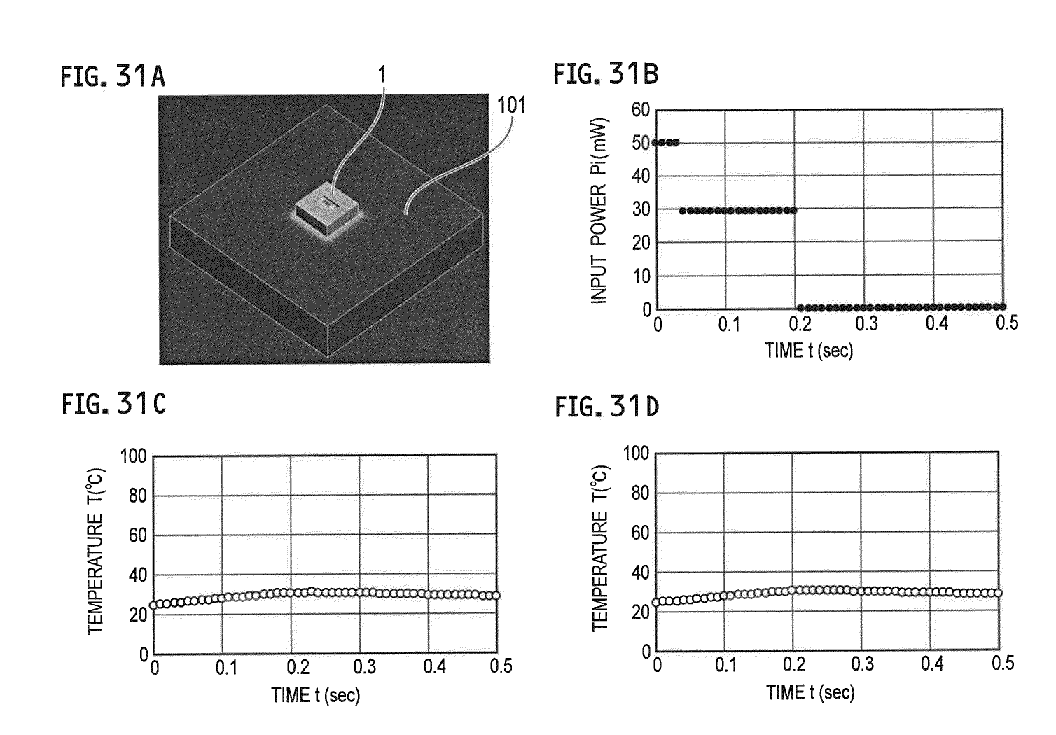

A schematic bird's-eye view configuration showing a state where the limiting-current type gas sensor according to the third embodiment is mounted on a printed circuit board 101 is expressed as shown in FIG. 31A. A graph showing a relationship between the input power Pᵢ (mW) to the limiting-current type gas sensor shown in FIG. 31A and time t (sec) is expressed as shown in FIG. 31B. Moreover, a graph showing a relationship between the temperature T (degrees C) and time t (sec) of a center portion of the Si substrate 1 in the case of inputting the input power Pᵢ shown in FIG. 31B is expressed as shown in FIG. 31C. Moreover, a graph showing a relationship between the temperature T (degrees C) and time t (sec) of a portion directly under of the Si substrate 1 of the printed circuit board 101 in the case of inputting the input power Pᵢ shown in FIG. 31B is expressed as shown in FIG. 31D. FIGS. 31A and 31B are the same as FIGS. 30A and 30B. Even if 29-mW input power Pᵢ is input after 50-mW input power Pᵢ is input only for 0.03 second as shown in FIGS. 31C and 31D, the temperature T of the center portion of Si substrate 1 and the temperature T of the Si substrate 1 portion directly under of the printed circuit board 101 is increased merely up to approximately 30 degrees C. More specifically the Si substrate 1 and the printed circuit board 101 are hardly subject to the effect due to the heating processing since the cavity C is formed in the portion directly under the beam structure body B.

### (Example of Timing Chart)

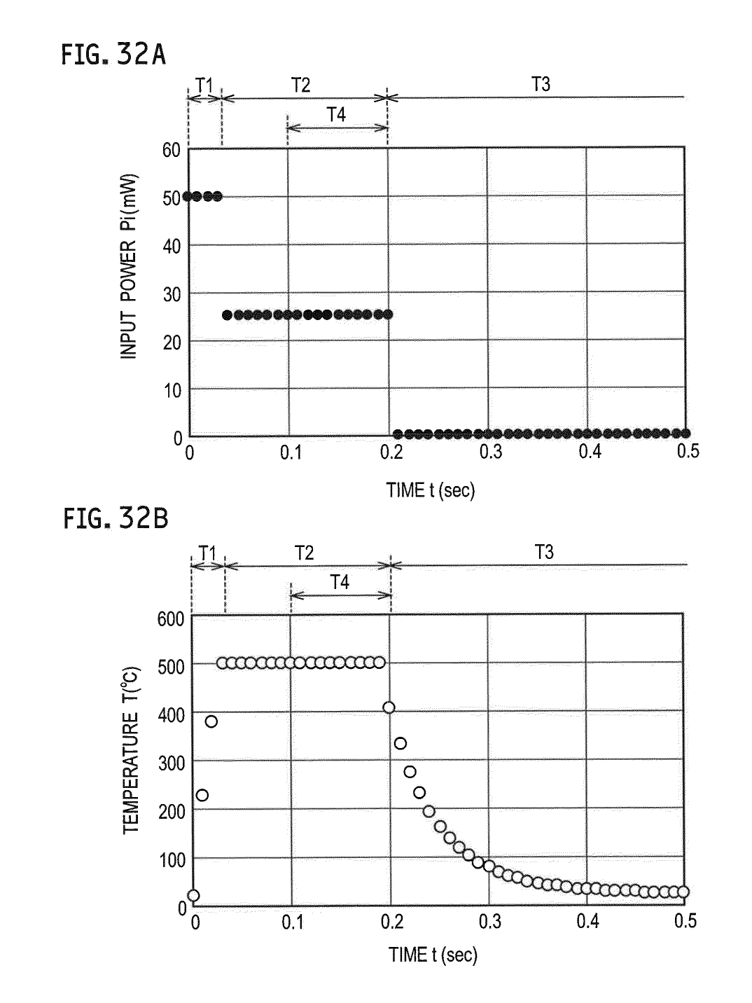

A graph showing a relationship between the input power Pᵢ (mW) to the limiting-current type gas sensor according to the third embodiment and time t (sec) is expressed as shown in FIG. 32A. Moreover, a graph showing a relationship between the temperature T (degrees C) of the beam structure body B and time t (sec) in the case of inputting the input power Pᵢ shown in FIG. 32A is expressed as shown in FIG. 32B. Here, a method of converting a resistance value (e.g., Pt resistance value) of the micro heater 2 into temperature is explained as a temperature measurement method. As shown in FIGS. 32A and 32B, after a first electric power (e.g., 50 mW) that is relatively large electric power is input only for a first time period T1, a second electric power (e.g., 25 mW, 29 mW) that is relatively small electric power is input only for a second time period T2. In this case, it is preferable to read data of the limiting-current type gas sensor at the second time period T2, and then to stop the input of electric power only for a third time period T3 after the second time period T2 elapses. Specifically, the sensor resistance and Pt resistance value is read out at the time period T4 during the time t is 0.1-0.2 second, and then the micro heater 2 is turned OFF at the time when the time t is 0.2 second to stop the input of the electric power.

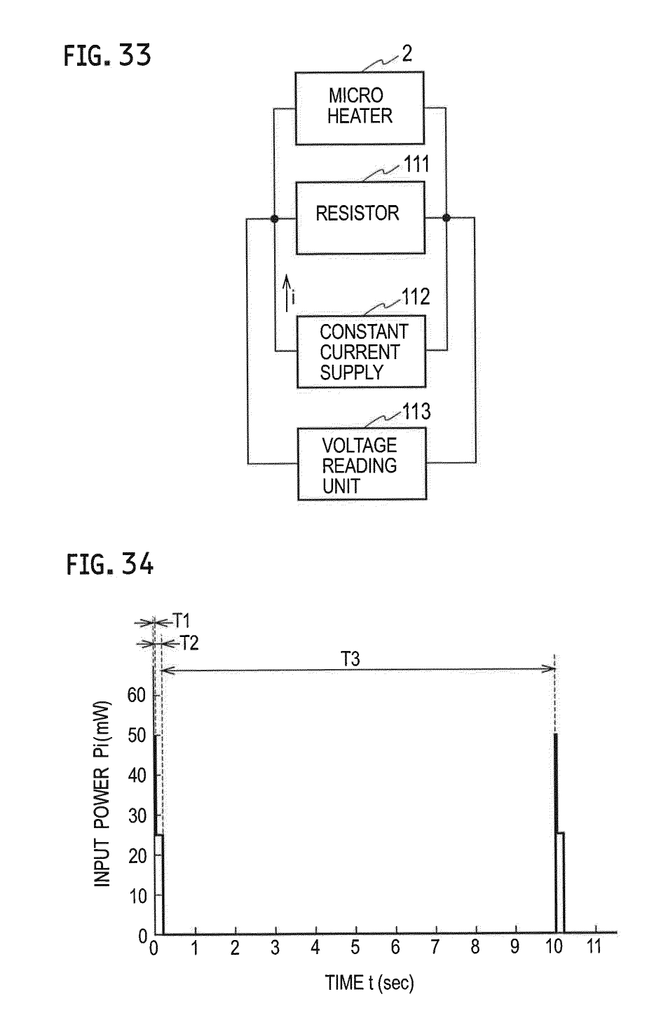

A schematic block configuration showing an example of Pt resistance measurement in the case of the inputting the input power Pᵢ shown in FIG. 32A is expressed as shown in FIG. 33. As shown in FIG. 33, R=rv/(ri−V) is realized, where R is resistance of the micro heater 2, r is resistance of the resistor 111, i is a current output from the constant current supply 112, and v is a read-out voltage of the voltage reading unit 113. Accuracy of the sensor value can be improved by calibrating the measured sensor resistance in accordance with a difference between the measured temperature and the target temperature.

### (Example of Power Consumption Reducing Application)

A graph showing an example of an intermittent sampling action of the limiting-current type gas sensor according to the third embodiment is expressed as shown in FIG. 34. For example, it is preferable to reduce power consumption by an intermittent sampling action since the electric power which can be input is limited if the limiting-current type gas sensor is applied to autonomous power-supply type sensor networks etc. Accordingly, the first electric power of 50 mW is input for the first time period T1 during the time t is 0-0.03 second. Moreover, the second electric power of 25 mW is input for the second time period T2 during the time t is 0.03-0.2 second. The data of the limiting-current type gas sensor is read out at the second time period T2. Furthermore, the micro heater 2 is turned OFF to stop the input of the electric power at the time when the time t is 0.2 second. An average power in such a case is approximately 6 mJ degree. Moreover, the average power 6 mJ/10 seconds=0.6 mW if measuring once in 10 seconds, and the average power 6 mJ/100 seconds=0.06 mW if measuring once in 100 seconds.

As mentioned above, in the third embodiment, the power consumption can be reduced since the electric power is input to the limiting-current type gas sensor in accordance with the heater power profile. Accordingly, the number of measurements can be increased, thereby improving measurement accuracy. Such a limiting-current type gas sensor is effective in particular to be applied to autonomous power-supply type sensor networks etc. to which the electric power which can be input is limited.

Although the first electric power is set as 50 mW and the second electric power is set as 25 mW or 29 mW in the present embodiment, needless to say, such values are merely examples. The first electric power should be an electric power which can reach the measured temperature (for example, 500 degrees C.) in a short time, and should be a relatively large electric power as compared with the second electric power. Moreover, the second electric power should be an electric power where the measured temperature (for example, 500 degrees C.) is stabilized, and should be relatively small electric power as compared with the first electric power. It is possible to appropriately change also each length of the first time period Ti, the second time period T2, and the third time period T3.

### Fourth Embodiment

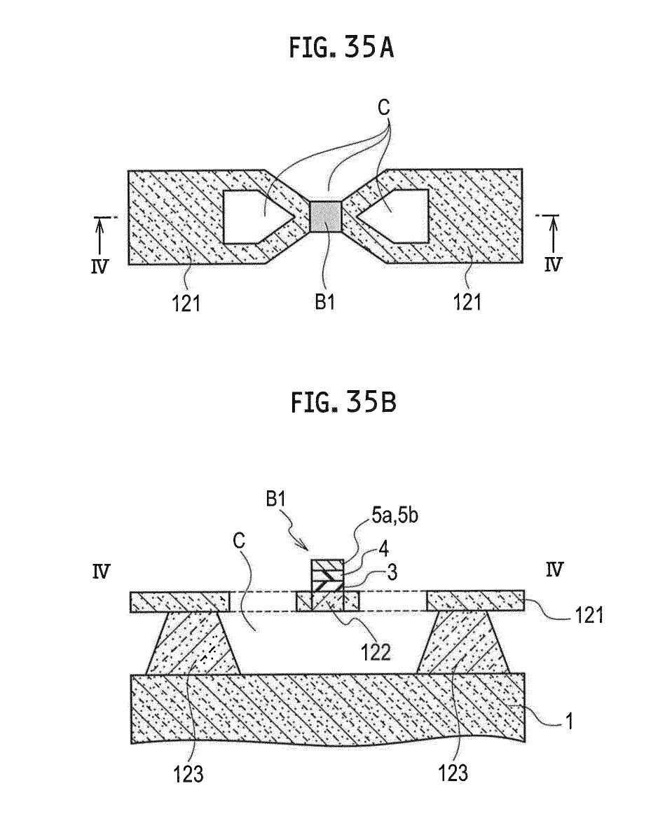

A schematic planar pattern configuration of the micro heater 2 of the limiting-current type gas sensor according to the fourth embodiment is expressed as shown in FIG. 35A. Moreover, a schematic cross-sectional structure taken in the line IV-IV of FIG. 35A is expressed as shown in FIG. 35B. As shown in FIGS. 35A and 35B, the beam-structured micro heater 2 is formed on the cavity C, and then the heated portion B1 is heated. Such a micro heater 2 can be formed by the following process flows.

Firstly, 3 um-Phosphorus Silicon Glass (PSG) 123 is formed on the Si substrate 1, SiN is formed, and then SiN patterning is performed (SiN is removed from a heavily doping portion). Next, Polysilicon is formed, for example, and phosphor is diffused to the polysilicon by an anneal process at approximately 1000 degrees C., to make heavily doped polysilicon 121. A portion in which SiN is contained is formed as lightly doped (undoped) polysilicon 122. Further, sensor structure (more specifically, an insulating film 3, e.g. a printed SiO₂ film and a printed Al₂O₃ film, a solid electrolyte layer 4, e.g., a YSZ film, and porous electrodes 5a, 5b, e.g., a Pt porous electrode) is formed, and then PSG etching is performed with BHF (5:1), thereby forming beam structure.

As mentioned above, according to the fourth embodiment, the beam-structured micro heater 2 can be easily formed on the cavity C.

### Fifth Embodiment

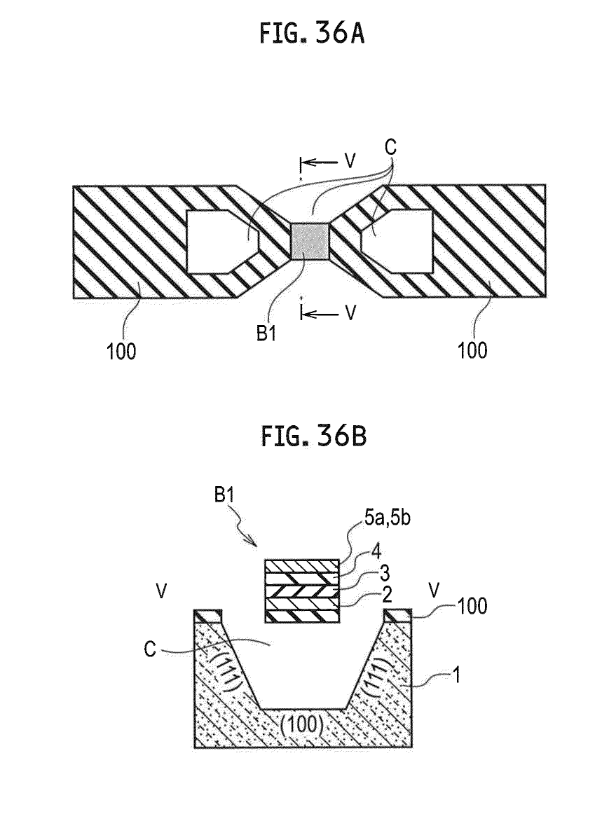

A schematic planar pattern configuration of the micro heater 2 of the limiting-current type gas sensor according to a fifth embodiment is expressed as shown in FIG. 36A. Moreover, a schematic cross-sectional structure taken in the line V-V of FIG. 36A is expressed as shown in FIG. 36B. The micro heater 2 may be formed in accordance with the following process flows:

Firstly, a supporting unit 100 which is a multilayered insulating film composed of SiO₂/SiN/SiO₂ is formed on the Si (100) substrate 1, and then a printed Pt heater (micro heater 2) is formed thereon. Next, sensor structure (more specifically, the insulating film 3, e.g. a printed SiO₂ film and a printed Al₂O₃ film, the solid electrolyte layer 4, e.g., a YSZ film, and the porous electrodes 5a, 5b, e.g., a Pt porous electrode) is formed on the micro heater 2. Furthermore, the cavity C is formed with performing anisotropic etching of Si substrate 1 using TMAH solution.

As mentioned above, according to the fifth embodiment, the beam-structured micro heater 2 can be easily formed on the cavity C.

### [Package]

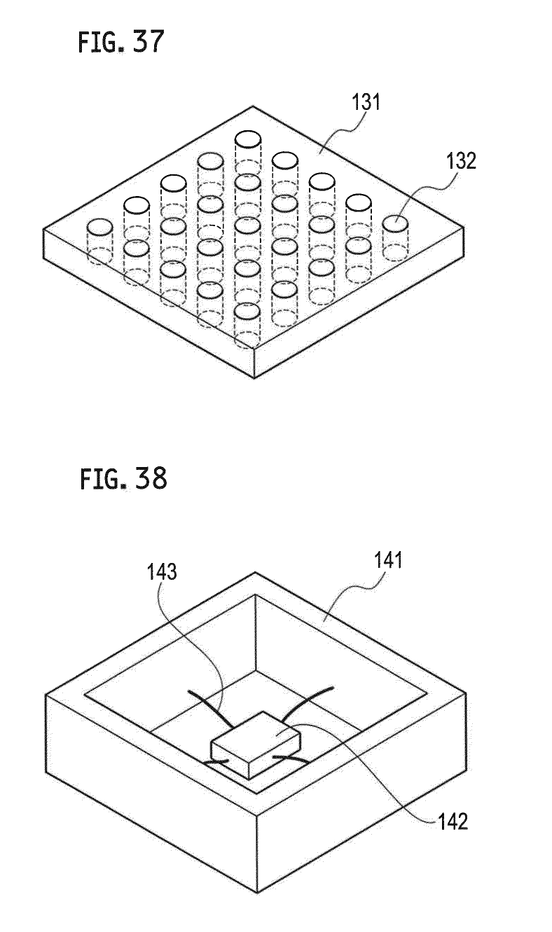

A schematic bird's-eye view configuration showing a sealing cover 131 of package for housing the limiting-current type gas sensor according to the first to fifth embodiments is expressed as shown in FIG. 37. As shown in FIG. 37, a large number of through holes 132 through which a gas can pass are formed in the sealing cover 131 of the package. The similar effect can be obtained even if the sealing cover 131 of the package is formed of porous materials.

A schematic bird's-eye view configuration showing a main unit 141 of the package for housing the limiting-current type gas sensor according to the first to fifth embodiments is expressed as shown in FIG. 38. As shown in FIG. 38, a limiting-current type gas sensor chip 142 including a plurality of terminals is housed in the main unit 141 of the package, and is electrically connected with a plurality of bonding wires 143. The sealing cover 131 is covered on an upper part of the main unit 141 of the package, and then is mounted on the printed circuit board 101 etc. with a solder.

### [Configuration Example of Sensor Node Using Energy Harvesting Power Supply]

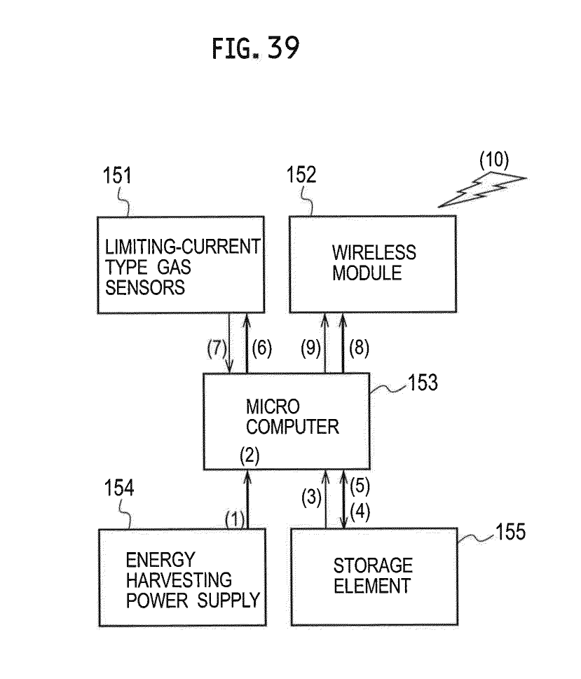

As shown in FIG. 39, the limiting-current type gas sensor (sensor node) according to the first to fifth embodiments includes: a limiting-current type gas sensors 151; a wireless module 152; a microcomputer 153; an energy harvesting power supply 154; and a storage element 155. A configuration of the limiting-current type gas sensors 151 is as explained in the first to fifth embodiments. The wireless module 152 is a module including an RF circuit etc. for transmitting and receiving radio frequency signals. The microcomputer 153 includes a management function of the energy harvesting power supply 154, and is configured to input the electric power from the energy harvesting power supply 154 to the limiting-current type gas sensors 151. At this time, the microcomputer 153 may be input the electric power in accordance with a heater power profile for saving the power consumption in the limiting-current type gas sensors 151. For example, after the first electric power that is relatively large electric power is input only for the first time period Ti, the second electric power that is relatively small electric power may be input only for the second time period T2. Moreover, the data is read out at the second time period T2, and then the input of electric power may be stopped only for the third time period T3 after the second time period T2 elapses. The energy harvesting power supply 154 harvests energies, e.g. a solar light, an illumination light, a vibration generated from machines, and a heat, thereby obtaining electric power. The storage element 155 is a lithium ion storage element etc. in which electric power can be electricity stored.

Hereinafter, operation of such a sensor node will now be explained. Firstly, as shown with the mark (1) in FIG. 39, the electric power from the energy harvesting power supply 154 is supplied to the microcomputer 153. Accordingly, the microcomputer 153 boosts voltage supplied from the energy harvesting power supply 154, as shown with the mark (2) in FIG. 39. Next, after reading the voltage of the storage element 155, as shown with the mark (3) in FIG. 39, the electric power is supplied to the storage element 155 and the electric power is extracted from the storage element 155 as shown with the marks (4) and (5) in FIG. 39. Next, the electric power is input to the limiting-current type gas sensors 151 on the basis of the heater power profile as shown with the mark (6) in FIG. 39, and then the data, such as sensor resistance, Pt resistance value, etc. is read out as shown with the mark (7) in FIG. 39. Next, the electric power is supplied to the wireless module 152 as shown with the mark (8) in FIG. 39, and then the data, such as sensor resistance, Pt resistance value, etc. is sent to the wireless module 152 as shown with the mark (9) in FIG. 39. Finally, as shown with the mark (10) in FIG. 39, the data, such as sensor resistance, Pt resistance value, etc. is wirelessly transmitted by the wireless module 152.

### [Sensor Network]

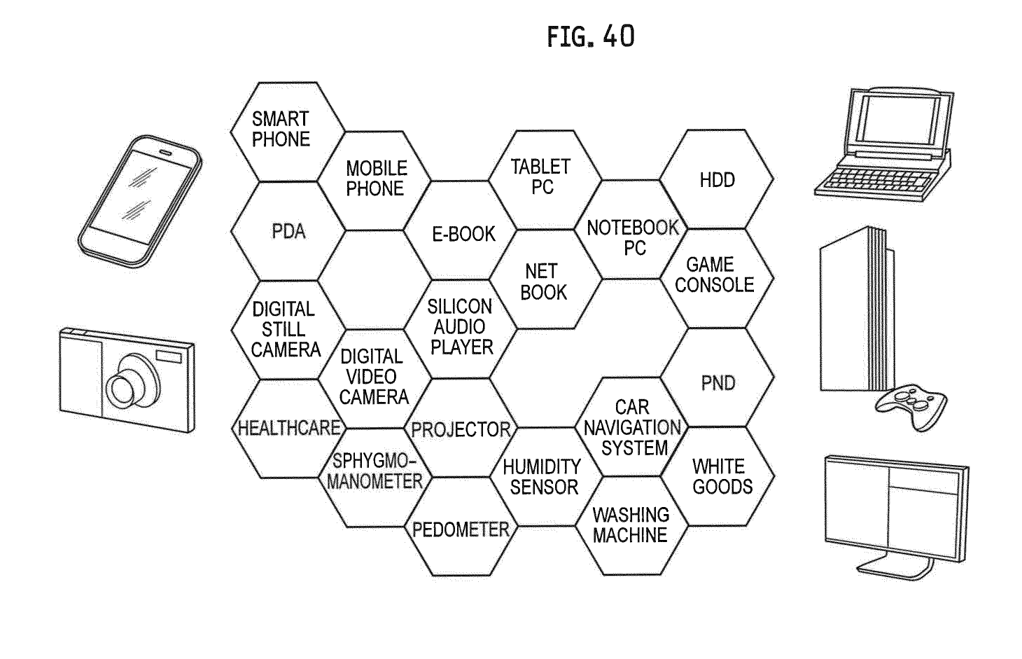

A schematic block configuration of a sensor network to which the limiting-current type gas sensor according to the first to fifth embodiments is applied is expressed as shown in FIG. 40. As shown in FIG. 40, the sensor network is a network interconnected to many sensors. Novel efforts using a sensor network in various fields, e.g. factories, medical care/health care, transport facilities, construction industries, agricultural facilities, and environmental management, have already been started. Since it is desired to use sensors with high durability in such fields, it is preferable to apply the limiting-current type gas sensor (for example, humidity sensor) according to the first to fifth embodiments. Such a humidity sensor is excellent in durability by using zirconia. Accordingly, it is possible to provide the reliable sensor network.

As explained above, according to the embodiments, there can be provided the limiting-current type gas sensor which can reduce power consumption, the fabrication method of such a limiting-current type gas sensor, and the sensor network system.

### Other Embodiments

The first to fifth embodiments has been described, as a disclosure including associated description and drawings to be construed as illustrative, not restrictive. This disclosure makes clear a variety of alternative embodiments, working examples, and operational techniques for those skilled in the art.

Such being the case, the embodiments cover a variety of embodiments, whether described or not. For example, if Na Super Ionic Conductor (NASICON) instead of the zirconia is used for the solid electrolyte layer 4, it is possible to detect density of carbon dioxide.

### INDUSTRIAL APPLICABILITY

The limiting-current type gas sensor according to the embodiments can be applied to an oxygen sensor and a humidity sensor. Such a sensor can also be applied to objects for an automobile exhaust gas and for sensor networks.

What is claimed is:

1. A limiting-current type gas sensor comprising:
an Si substrate;
a micro heater formed on the Si substrate or under the Si substrate;
a solid electrolyte layer having ion conductivity formed on the Si substrate;
a pair of positive and negative porous electrodes adhesively formed on the solid electrolyte layer; and
a detection circuit configured to detect predetermined gas density in measured gas with a limiting current method by applying voltage between the pair of the positive and negative porous electrodes.

2. The limiting-current type gas sensor according to claim 1, further comprising
a porous membrane adhesively formed on the solid electrolyte layer and the pair of the positive and negative porous electrodes.

3. The limiting-current type gas sensor according to claim 1, wherein
the micro heater comprises any one of a printed Pt heater formed by printing or polysilicon.

4. The limiting-current type gas sensor according to claim 1, wherein
the solid electrolyte layer comprises a printed film containing at least one of ZrO₂—Y₂O₃, SiO₂, or Al₂O₃ formed by printing.

5. The limiting-current type gas sensor according to claim 1, wherein
the pair of the positive and negative porous electrodes comprises a Pt printed electrode formed by printing.

6. The limiting-current type gas sensor according to claim 2, wherein
the porous membrane comprises a printed film containing at least one kind of Al₂O₃, SiO₂, MgO and an amorphous glass formed by printing.

7. The limiting-current type gas sensor according to claim 1, wherein
the detection circuit detects oxygen density on the basis of limiting current.

8. The limiting-current type gas sensor according to claim 1, wherein
the detection circuit detects vapor density on the basis of limiting current.

9. The limiting-current type gas sensor according to claim 1, wherein
the both of the pair of the positive and negative porous electrodes are formed on the solid electrolyte layer.

10. The limiting-current type gas sensor according to claim 1, wherein
one of the pairs of the positive and negative porous electrodes is formed on the solid electrolyte layer, and another thereof may is under the solid electrolyte layer.

11. The limiting-current type gas sensor according to claim 2, wherein
roughness is formed on a surface of the porous membrane.

12. The limiting-current type gas sensor according to claim 1, wherein
a both-ends-supported beam structure body is formed on a cavity formed in the Si substrate.

13. The limiting-current type gas sensor according to claim 12, wherein
a supporting unit of the beam structure body comprises a multilayered insulating film composed of SiO₂ and SiN.

14. The limiting-current type gas sensor according to claim 1, further comprising
a microcomputer configured to input electric power on the basis of a heater power profile for saving power consumption in the limiting-current type gas sensor.

15. The limiting-current type gas sensor according to claim 14, wherein
the microcomputer input a second electric power that is relatively small electric power only for the second time period after inputting a first electric power that is relatively large electric power only for a first time period.

16. The limiting-current type gas sensor according to claim 15, wherein
the microcomputer reads data at the second time period and then stops the input of the electric power only for a third time period after the second time period elapses.

17. The limiting-current type gas sensor according to claim 14, further comprising
an energy harvesting power supply, wherein
the microcomputer controls the electric power input from the energy harvesting power supply.

18. A fabrication method of a limiting-current type gas sensor, the method comprising:
forming a Si substrate;
forming a micro heater on the Si substrate or under the Si substrate;
forming a solid electrolyte layer having ion conductivity on the Si substrate; and
adhesively forming a pair of positive and negative porous electrodes on the solid electrolyte layer.

19. The fabrication method of the limiting-current type gas sensor according to claim 18 further comprising
adhesively forming a porous membrane on the solid electrolyte layer and the pair of the positive and negative porous electrodes.

20. A sensor network system comprising a limiting-current type gas sensor, the limiting-current type gas sensor comprising:
an Si substrate;
a micro heater formed on the Si substrate or under the Si substrate;
a solid electrolyte layer having ion conductivity formed on the Si substrate;
a pair of positive and negative porous electrodes adhesively formed on the solid electrolyte layer; and
a detection circuit configured to detect predetermined gas density in measured gas with a limiting current method by applying voltage between the pair of the positive and negative porous electrodes.
